(19) United States
(12) Patent Application Publication
(10) Pub. No.: US 2026/0238455 A1
(43) Pub. Date: Aug. 13, 2026

(54) TECHNIQUES FOR SWITCHING FREQUENCY FOR UPLINK TRANSMISSION FOR A PLURALITY OF BANDS

(71) Applicant: QUALCOMM Incorporated, San Diego, CA (US)

(72) Inventors: Kazuki TAKEDA, Minato-ku (JP); Yiqing CAO, Beijing (CN)

(21) Appl. No.: 19/155,508

(22) PCT Filed: Feb. 17, 2023
(86) PCT No.: PCT/CN2023/076744

§ 371 Date: Aug. 11, 2025

(51) Int. Cl. H04L 5/00; H04L 27/26

(52) U.S. Cl. CPC H04L 5/0098; H04L 27/26025

(57) ABSTRACT

Methods, systems, and devices for wireless communications are described. The techniques described herein relate to frequency switching bands for uplink transmission for multiple frequency bands. A first network node (e.g., a user equipment) transmits an indication of a capability to switch uplink transmit chains for communications on component carriers over a quantity of frequency bands. The quantity of frequency bands is greater than two and the capability indicates simultaneous uplink transmissions over fewer than the quantity of frequency bands. The first network node receives control information to switch from a first set of frequency bands to communications over a second set of frequency bands. The first network node switches the uplink transmit chains, where a subcarrier spacing (SCS) of a slot in which the switch occurs is based on a rule defining whether candidate SCS values are associated with deactivated component carriers or dormant bandwidth parts.

### CROSS REFERENCE

The present Application is a 371 national phase filing of International PCT Application No. PCT/CN2023/076744 by TAKEDA et al., entitled “TECHNIQUES FOR SWITCHING FREQUENCY FOR UPLINK TRANSMISSION FOR A PLURALITY OF BANDS,” filed Feb. 17, 2023, which is assigned to the assignee hereof, and which is expressly incorporated by reference in its entirety herein.

### INTRODUCTION

The following relates to wireless communications that involve frequency switching for uplink transmission over multiple bands.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for switching to different frequencies for uplink transmission over multiple bands. When a user equipment (UE) is indicated to switch a frequency band for an uplink transmit chain, and at least one uplink frequency band is a component carrier that is deactivated or within a dormant bandwidth part (BWP) (which may occur if the quantity of supported frequency bands is more than two, but where the UE only has two transmit chains), the UE may determine the subcarrier spacing (SCS) of the slot in which the frequency switch occurs based on a rule that defines whether candidate SCSs are associated with deactivated component carriers or component carriers that are in dormant BWPs. The UE may use an equation that defines that the SCS of the slot is equal to the maximum SCS of each possible uplink carrier. In one option, the rule is that the possible or candidate uplink carriers whose SCS is to be considered do not include carriers that are deactivated or that are in dormant BWPs. In another option, the rule is that the possible or candidate uplink carriers whose SCS is to be considered do include deactivated carriers or carriers in dormant bandwidth parts. The SCS used for the deactivated carriers or carriers associated with dormant BWPs may be indicated by the network in a radio resource control (RRC) message associated with each BWP.

A method is described. The method may include a memory, at least one processor coupled to the memory, where the at least one processor is configured to, transmit an indication of a capability of the first network node to switch uplink transmit chains for communications on component carriers over a quantity of frequency bands, where the quantity of frequency bands is greater than two and where the capability indicates that the first network node is capable of simultaneous uplink transmissions over fewer than the quantity of frequency bands, receive control information that indicates a switch from communications over a first set of frequency bands to communications over a second set of frequency bands in accordance with the capability, the second set of frequency bands and the first set of frequency bands being different, and switch the uplink transmit chains of the first network node in accordance with the control information, where a SCS of a slot in which at least a portion of the switch occurs is based on a rule that defines whether candidate SCS values are associated with deactivated component carriers or component carriers that are in dormant BWPs.

An apparatus is described. The apparatus may include a processor, memory coupled with the processor, and instructions stored in the memory. The instructions may be executable by the processor to cause the apparatus to a memory, at least one processor couple to the memory, where the at least one processor is configured to, transmit an indication of a capability of the first network node to switch uplink transmit chains for communications on component carriers over a quantity of frequency bands, where the quantity of frequency bands is greater than two and where the capability indicates that the first network node is capable of simultaneous uplink transmissions over fewer than the quantity of frequency bands, receive control information that indicates a switch from communications over a first set of frequency bands to communications over a second set of frequency bands in accordance with the capability, the second set of frequency bands and the first set of frequency bands being different, and switch the uplink transmit chains of the first network node in accordance with the control information, where a SCS of a slot in which at least a portion of the switch occurs is based on a rule that defines whether candidate SCS values are associated with deactivated component carriers or component carriers that are in dormant BWPs.

Another apparatus is described. The apparatus may include means for a memory, means for at least one processor coupled to the memory, where the at least one processor is configured to, means for transmit an indication of a capability of the first network node to switch uplink transmit chains for communications on component carriers over a quantity of frequency bands, where the quantity of frequency bands is greater than two and where the capability indicates that the first network node is capable of simultaneous uplink transmissions over fewer than the quantity of frequency bands, means for receive control information that indicates a switch from communications over a first set of frequency bands to communications over a second set of frequency bands in accordance with the capability, the second set of frequency bands and the first set of frequency bands being different, and means for switch the uplink transmit chains of the first network node in accordance with the control information, where a SCS of a slot in which at least a portion of the switch occurs is based on a rule that defines whether candidate SCS values are associated with deactivated component carriers or component carriers that are in dormant BWPs.

A non-transitory computer-readable medium storing code is described. The code may include instructions executable by a processor to a memory, at least one processor couple to the memory, where the at least one processor is configured to, transmit an indication of a capability of the first network node to switch uplink transmit chains for communications on component carriers over a quantity of frequency bands, where the quantity of frequency bands is greater than two and where the capability indicates that the first network node is capable of simultaneous uplink transmissions over fewer than the quantity of frequency bands, receive control information that indicates a switch from communications over a first set of frequency bands to communications over a second set of frequency bands in accordance with the capability, the second set of frequency bands and the first set of frequency bands being different, and switch the uplink transmit chains of the first network node in accordance with the control information, where a SCS of a slot in which at least a portion of the switch occurs is based on a rule that defines whether candidate SCS values are associated with deactivated component carriers or component carriers that are in dormant BWPs.

Some examples of the method, apparatuses, and non-transitory computer-readable medium described herein may further include operations, features, means, or instructions for determine the SCS of the slot in accordance with the rule, where the rule defines that the SCS of the slot may be based on a maximum numerology of the candidate SCS values, and where all of the candidate SCS values may be associated with activated component carriers or component carriers that may be in non-dormant BWPs.

Some examples of the method, apparatuses, and non-transitory computer-readable medium described herein may further include operations, features, means, or instructions for determine the SCS of the slot in accordance with the rule, where the rule defines that the SCS of the slot may be based on a maximum numerology of the candidate SCS values, and where the candidate SCS values may be associated with a combination of activated component carriers or component carriers that may be in non-dormant BWPs and the deactivated component carriers or the component carriers that may be in dormant BWPs.

In some examples of the method, apparatuses, and non-transitory computer-readable medium described herein, the candidate SCS values associated with the deactivated component carriers or the component carriers that may be in dormant BWPs may be based on a first active uplink BWP identification associated with respective ones of the deactivated component carriers or dormant BWPs.

In some examples of the method, apparatuses, and non-transitory computer-readable medium described herein, the quantity of frequency bands may be three or four.

In some examples of the method, apparatuses, and non-transitory computer-readable medium described herein, the capability indicates that the first network node may be capable of simultaneous uplink transmissions over a maximum of two frequency bands using two uplink transmit chains.

In some examples of the method, apparatuses, and non-transitory computer-readable medium described herein, the first set of frequency bands may be a single frequency band over which the first network node communicates using a first uplink transmit chain and a second uplink transmit chain and the second set of frequency bands includes a first frequency band over which the first network node communicates using the first uplink transmit chain and a second frequency band over which the first network node communicates using the second uplink transmit chain.

In some examples of the method, apparatuses, and non-transitory computer-readable medium described herein, the first set of frequency bands includes a first frequency band over which the first network node communicates using a first uplink transmit chain and a second frequency band over which the first network node communicates using a second uplink transmit chain and the second set of frequency bands may be a single frequency band over which the first network node communicates using both the first uplink transmit chain and the second uplink transmit chain.

In some examples of the method, apparatuses, and non-transitory computer-readable medium described herein, the first set of frequency bands may be a first single frequency band over which the first network node communicates using a first uplink transmit chain and a second uplink transmit chain and the second set of frequency bands may be a second single frequency band over which the first network node communicates using both the first uplink transmit chain and the second uplink transmit chain.

In some examples of the method, apparatuses, and non-transitory computer-readable medium described herein, the first set of frequency bands includes a first frequency band over which the first network node communicates using a first uplink transmit chain and a second frequency band over which the first network node communicates using a second uplink transmit chain and the second set of frequency bands includes a third frequency band over which the first network node communicates using the first uplink transmit chain and a fourth frequency band over which the first network node communicates using the second uplink transmit chain.

In some examples of the method, apparatuses, and non-transitory computer-readable medium described herein, the control information indicates whether the component carriers may be activated or deactivated.

In some examples of the method, apparatuses, and non-transitory computer-readable medium described herein, the control information indicates whether the component carriers may be in dormant BWPs or non-dormant BWPs.

A method is described. The method may include a memory, at least one processor coupled to the memory, where the at least one processor is configured to, receive, from a second network node, an indication of a capability of the second network node to switch uplink transmit chains for communications on component carriers over a quantity of frequency bands, where the quantity of frequency bands is greater than two and where the capability indicates that the second network node is capable of simultaneous uplink transmissions over fewer than the quantity of frequency bands, transmit, to the second network node, control information that indicates a switch from communications over a first set of frequency bands to communications over a second set of frequency bands in accordance with the capability, the second set of frequency bands and the first set of frequency bands being different, switch the uplink transmit chains of the second network node in accordance with the control information, where a SCS of a slot in which at least a portion of the switch occurs is based on a rule that defines whether candidate SCS values are associated with deactivated component carriers or component carriers that are in dormant BWPs, and refrain from transmitting second control information that indicates a second switch from communications over the second set of frequency bands to communications over the first set of frequency bands or a third set of frequency bands during the slot.

An apparatus is described. The apparatus may include a processor, memory coupled with the processor, and instructions stored in the memory. The instructions may be executable by the processor to cause the apparatus to a memory, at least one processor couple to the memory, where the at least one processor is configured to, receive, from a second network node, an indication of a capability of the second network node to switch uplink transmit chains for communications on component carriers over a quantity of frequency bands, where the quantity of frequency bands is greater than two and where the capability indicates that the second network node is capable of simultaneous uplink transmissions over fewer than the quantity of frequency bands, transmit, to the second network node, control information that indicates a switch from communications over a first set of frequency bands to communications over a second set of frequency bands in accordance with the capability, the second set of frequency bands and the first set of frequency bands being different, switch the uplink transmit chains of the second network node in accordance with the control information, where a SCS of a slot in which at least a portion of the switch occurs is based on a rule that defines whether candidate SCS values are associated with deactivated component carriers or component carriers that are in dormant BWPs, and refrain from transmit second control information that indicates a second switch from communications over the second set of frequency bands to communications over the first set of frequency bands or a third set of frequency bands during the slot.

Another apparatus is described. The apparatus may include means for a memory, means for at least one processor coupled to the memory, where the at least one processor is configured to, means for receive, from a second network node, an indication of a capability of the second network node to switch uplink transmit chains for communications on component carriers over a quantity of frequency bands, where the quantity of frequency bands is greater than two and where the capability indicates that the second network node is capable of simultaneous uplink transmissions over fewer than the quantity of frequency bands, means for transmit, to the second network node, control information that indicates a switch from communications over a first set of frequency bands to communications over a second set of frequency bands in accordance with the capability, the second set of frequency bands and the first set of frequency bands being different, means for switch the uplink transmit chains of the second network node in accordance with the control information, where a SCS of a slot in which at least a portion of the switch occurs is based on a rule that defines whether candidate SCS values are associated with deactivated component carriers or component carriers that are in dormant BWPs, and means for refrain from transmitting second control information that indicates a second switch from communications over the second set of frequency bands to communications over the first set of frequency bands or a third set of frequency bands during the slot.

A non-transitory computer-readable medium storing code is described. The code may include instructions executable by a processor to a memory, at least one processor couple to the memory, where the at least one processor is configured to, receive, from a second network node, an indication of a capability of the second network node to switch uplink transmit chains for communications on component carriers over a quantity of frequency bands, where the quantity of frequency bands is greater than two and where the capability indicates that the second network node is capable of simultaneous uplink transmissions over fewer than the quantity of frequency bands, transmit, to the second network node, control information that indicates a switch from communications over a first set of frequency bands to communications over a second set of frequency bands in accordance with the capability, the second set of frequency bands and the first set of frequency bands being different, switch the uplink transmit chains of the second network node in accordance with the control information, where a SCS of a slot in which at least a portion of the switch occurs is based on a rule that defines whether candidate SCS values are associated with deactivated component carriers or component carriers that are in dormant BWPs, and refrain from transmit second control information that indicates a second switch from communications over the second set of frequency bands to communications over the first set of frequency bands or a third set of frequency bands during the slot.

In some examples of the method, apparatuses, and non-transitory computer-readable medium described herein, the at least one processor may be further configured to determine the SCS of the slot in accordance with the rule, the rule defines that the SCS of the slot may be based on a maximum numerology of the candidate SCS values, and all of the candidate SCS values may be associated with activated component carriers or component carriers that may be in non-dormant BWPs.

In some examples of the method, apparatuses, and non-transitory computer-readable medium described herein, the at least one processor may be further configured to determine the SCS of the slot in accordance with the rule, the rule defines that the SCS of the slot may be based on a maximum numerology of the candidate SCS values, and the candidate SCS values may be associated with a combination of activated component carriers or component carriers that may be in non-dormant BWPs and the deactivated component carriers or the component carriers that may be in dormant BWPs.

In some examples of the method, apparatuses, and non-transitory computer-readable medium described herein, the candidate SCS values associated with the deactivated component carriers or the component carriers that may be in dormant BWPs may be based on a first active uplink BWP identification associated with respective ones of the deactivated component carriers or dormant BWPs.

In some examples of the method, apparatuses, and non-transitory computer-readable medium described herein, the quantity of frequency bands may be three or four.

In some examples of the method, apparatuses, and non-transitory computer-readable medium described herein, the capability indicates that the second network node may be capable of simultaneous uplink transmissions over a maximum of two frequency bands using two uplink transmit chains.

In some examples of the method, apparatuses, and non-transitory computer-readable medium described herein, the first set of frequency bands may be a single frequency band over which the second network node communicates using a first uplink transmit chain and a second uplink transmit chain and the second set of frequency bands includes a first frequency band over which the second network node communicates using the first uplink transmit chain and a second frequency band over which the second network node communicates using the second uplink transmit chain.

In some examples of the method, apparatuses, and non-transitory computer-readable medium described herein, the first set of frequency bands includes a first frequency band over which the second network node communicates using a first uplink transmit chain and a second frequency band over which the second network node communicates using a second uplink transmit chain and the second set of frequency bands may be a single frequency band over which the second network node communicates using both the first uplink transmit chain and the second uplink transmit chain.

In some examples of the method, apparatuses, and non-transitory computer-readable medium described herein, the first set of frequency bands may be a first single frequency band over which the second network node communicates using a first uplink transmit chain and a second uplink transmit chain and the second set of frequency bands may be a second single frequency band over which the second network node communicates using both the first uplink transmit chain and the second uplink transmit chain.

In some examples of the method, apparatuses, and non-transitory computer-readable medium described herein, the first set of frequency bands includes a first frequency band over which the second network node communicates using a first uplink transmit chain and a second frequency band over which the second network node communicates using a second uplink transmit chain and the second set of frequency bands includes a third frequency band over which the second network node communicates using the first uplink transmit chain and a fourth frequency band over which the second network node communicates using the second uplink transmit chain.

In some examples of the method, apparatuses, and non-transitory computer-readable medium described herein, the control information indicates whether the component carriers may be activated or deactivated.

In some examples of the method, apparatuses, and non-transitory computer-readable medium described herein, the control information indicates whether the component carriers may be in dormant BWPs or non-dormant BWPs.

A method is described. The method may include transmitting an indication of a capability of the first network node to switch uplink transmit chains for communications on component carriers over a quantity of frequency bands, where the quantity of frequency bands is greater than two and where the capability indicates that the first network node is capable of simultaneous uplink transmissions over fewer than the quantity of frequency bands, receiving control information that indicates a switch from communications over a first set of frequency bands to communications over a second set of frequency bands in accordance with the capability, the second set of frequency bands and the first set of frequency bands being different, and switching the uplink transmit chains of the first network node in accordance with the control information, where a SCS of a slot in which at least a portion of the switch occurs is based on a rule that defines whether candidate SCS values are associated with deactivated component carriers or component carriers that are in dormant BWPs.

An apparatus is described. The apparatus may include a processor, memory coupled with the processor, and instructions stored in the memory. The instructions may be executable by the processor to cause the apparatus to transmit an indication of a capability of the first network node to switch uplink transmit chains for communications on component carriers over a quantity of frequency bands, where the quantity of frequency bands is greater than two and where the capability indicates that the first network node is capable of simultaneous uplink transmissions over fewer than the quantity of frequency bands, receive control information that indicates a switch from communications over a first set of frequency bands to communications over a second set of frequency bands in accordance with the capability, the second set of frequency bands and the first set of frequency bands being different, and switch the uplink transmit chains of the first network node in accordance with the control information, where a SCS of a slot in which at least a portion of the switch occurs is based on a rule that defines whether candidate SCS values are associated with deactivated component carriers or component carriers that are in dormant BWPs.

Another apparatus is described. The apparatus may include means for transmitting an indication of a capability of the first network node to switch uplink transmit chains for communications on component carriers over a quantity of frequency bands, where the quantity of frequency bands is greater than two and where the capability indicates that the first network node is capable of simultaneous uplink transmissions over fewer than the quantity of frequency bands, means for receiving control information that indicates a switch from communications over a first set of frequency bands to communications over a second set of frequency bands in accordance with the capability, the second set of frequency bands and the first set of frequency bands being different, and means for switching the uplink transmit chains of the first network node in accordance with the control information, where a SCS of a slot in which at least a portion of the switch occurs is based on a rule that defines whether candidate SCS values are associated with deactivated component carriers or component carriers that are in dormant BWPs.

A non-transitory computer-readable medium storing code is described. The code may include instructions executable by a processor to transmit an indication of a capability of the first network node to switch uplink transmit chains for communications on component carriers over a quantity of frequency bands, where the quantity of frequency bands is greater than two and where the capability indicates that the first network node is capable of simultaneous uplink transmissions over fewer than the quantity of frequency bands, receive control information that indicates a switch from communications over a first set of frequency bands to communications over a second set of frequency bands in accordance with the capability, the second set of frequency bands and the first set of frequency bands being different, and switch the uplink transmit chains of the first network node in accordance with the control information, where a SCS of a slot in which at least a portion of the switch occurs is based on a rule that defines whether candidate SCS values are associated with deactivated component carriers or component carriers that are in dormant BWPs.

Some examples of the method, apparatuses, and non-transitory computer-readable medium described herein may further include operations, features, means, or instructions for determining the SCS of the slot in accordance with the rule, where the rule defines that the SCS of the slot may be based on a maximum numerology of the candidate SCS values, and where all of the candidate SCS values may be associated with activated component carriers or component carriers that may be in non-dormant BWPs.

Some examples of the method, apparatuses, and non-transitory computer-readable medium described herein may further include operations, features, means, or instructions for determining the SCS of the slot in accordance with the rule, where the rule defines that the SCS of the slot may be based on a maximum numerology of the candidate SCS values, and where the candidate SCS values may be associated with a combination of activated component carriers or component carriers that may be in non-dormant BWPs and the deactivated component carriers or the component carriers that may be in dormant BWPs.

A method is described. The method may include receiving, from a second network node, an indication of a capability of the second network node to switch uplink transmit chains for communications on component carriers over a quantity of frequency bands, where the quantity of frequency bands is greater than two and where the capability indicates that the second network node is capable of simultaneous uplink transmissions over fewer than the quantity of frequency bands, transmitting, to the second network node, control information that indicates a switch from communications over a first set of frequency bands to communications over a second set of frequency bands in accordance with the capability, the second set of frequency bands and the first set of frequency bands being different, switching the uplink transmit chains of the second network node in accordance with the control information, where a SCS of a slot in which at least a portion of the switch occurs is based on a rule that defines whether candidate SCS values are associated with deactivated component carriers or component carriers that are in dormant BWPs, and refraining from transmitting second control information that indicates a second switch from communications over the second set of frequency bands to communications over the first set of frequency bands or a third set of frequency bands during the slot.

An apparatus is described. The apparatus may include a processor, memory coupled with the processor, and instructions stored in the memory. The instructions may be executable by the processor to cause the apparatus to receive, from a second network node, an indication of a capability of the second network node to switch uplink transmit chains for communications on component carriers over a quantity of frequency bands, where the quantity of frequency bands is greater than two and where the capability indicates that the second network node is capable of simultaneous uplink transmissions over fewer than the quantity of frequency bands, transmit, to the second network node, control information that indicates a switch from communications over a first set of frequency bands to communications over a second set of frequency bands in accordance with the capability, the second set of frequency bands and the first set of frequency bands being different, switch the uplink transmit chains of the second network node in accordance with the control information, where a SCS of a slot in which at least a portion of the switch occurs is based on a rule that defines whether candidate SCS values are associated with deactivated component carriers or component carriers that are in dormant BWPs, and refrain from transmitting second control information that indicates a second switch from communications over the second set of frequency bands to communications over the first set of frequency bands or a third set of frequency bands during the slot.

Another apparatus is described. The apparatus may include means for receiving, from a second network node, an indication of a capability of the second network node to switch uplink transmit chains for communications on component carriers over a quantity of frequency bands, where the quantity of frequency bands is greater than two and where the capability indicates that the second network node is capable of simultaneous uplink transmissions over fewer than the quantity of frequency bands, means for transmitting, to the second network node, control information that indicates a switch from communications over a first set of frequency bands to communications over a second set of frequency bands in accordance with the capability, the second set of frequency bands and the first set of frequency bands being different, means for switching the uplink transmit chains of the second network node in accordance with the control information, where a SCS of a slot in which at least a portion of the switch occurs is based on a rule that defines whether candidate SCS values are associated with deactivated component carriers or component carriers that are in dormant BWPs, and means for refraining from transmitting second control information that indicates a second switch from communications over the second set of frequency bands to communications over the first set of frequency bands or a third set of frequency bands during the slot.

A non-transitory computer-readable medium storing code is described. The code may include instructions executable by a processor to receive, from a second network node, an indication of a capability of the second network node to switch uplink transmit chains for communications on component carriers over a quantity of frequency bands, where the quantity of frequency bands is greater than two and where the capability indicates that the second network node is capable of simultaneous uplink transmissions over fewer than the quantity of frequency bands, transmit, to the second network node, control information that indicates a switch from communications over a first set of frequency bands to communications over a second set of frequency bands in accordance with the capability, the second set of frequency bands and the first set of frequency bands being different, switch the uplink transmit chains of the second network node in accordance with the control information, where a SCS of a slot in which at least a portion of the switch occurs is based on a rule that defines whether candidate SCS values are associated with deactivated component carriers or component carriers that are in dormant BWPs, and refrain from transmitting second control information that indicates a second switch from communications over the second set of frequency bands to communications over the first set of frequency bands or a third set of frequency bands during the slot.

Some examples of the method, apparatuses, and non-transitory computer-readable medium described herein may further include operations, features, means, or instructions for determining the SCS of the slot in accordance with the rule, where the rule defines that the SCS of the slot may be based on a maximum numerology of the candidate SCS values, and where all of the candidate SCS values may be associated with activated component carriers or component carriers that may be in non-dormant BWPs.

Some examples of the method, apparatuses, and non-transitory computer-readable medium described herein may further include operations, features, means, or instructions for determining the SCS of the slot in accordance with the rule, where the rule defines that the SCS of the slot may be based on a maximum numerology of the candidate SCS values, and where the candidate SCS values may be associated with a combination of activated component carriers or component carriers that may be in non-dormant BWPs and the deactivated component carriers or the component carriers that may be in dormant BWPs.

### BRIEF DESCRIPTION OF THE DRAWINGS

FIG. 1 illustrates an example of a wireless communications system that supports techniques for frequency switching for uplink transmission for multiple bands in accordance with one or more aspects of the present disclosure.

FIG. 2 illustrates an example of a wireless communication system that supports techniques for frequency switching for uplink transmission for multiple bands in accordance with one or more aspects of the present disclosure.

FIG. 3 illustrates an example of an uplink transmission switch that supports techniques for frequency switching for uplink transmission for multiple bands in accordance with one or more aspects of the present disclosure.

FIG. 4 illustrates an example of a process flow that supports techniques for frequency switching for uplink transmission for multiple bands in accordance with one or more aspects of the present disclosure.

FIGS. 5 and 6 illustrate block diagrams of devices that support techniques for frequency switching for uplink transmission for a set of multiple bands in accordance with one or more aspects of the present disclosure.

FIG. 7 illustrates a block diagram of a communications manager that supports techniques for frequency switching for uplink transmission for a set of multiple bands in accordance with one or more aspects of the present disclosure.

FIG. 8 illustrates a diagram of a system including a device that supports techniques for frequency switching for uplink transmission for a set of multiple bands in accordance with one or more aspects of the present disclosure.

FIGS. 9 and 10 illustrate block diagrams of devices that support techniques for frequency switching for uplink transmission for a set of multiple bands in accordance with one or more aspects of the present disclosure.

FIG. 11 illustrates a block diagram of a communications manager that supports techniques for frequency switching for uplink transmission for a set of multiple bands in accordance with one or more aspects of the present disclosure.

FIG. 12 illustrates a diagram of a system including a device that supports techniques for frequency switching for uplink transmission for a set of multiple bands in accordance with one or more aspects of the present disclosure.

FIGS. 13 and 14 illustrate flowcharts showing methods that support techniques for frequency switching for uplink transmission for multiple bands in accordance with one or more aspects of the present disclosure.

### DETAILED DESCRIPTION

Some wireless communications systems may include multiple frequency bands for uplink transmissions used for transmitting data from a user equipment (UE) to a network entity. A UE may communicate over two uplink transmit chains simultaneously, either in the same frequency band or in different frequency bands. In some cases, more than two frequency bands may be available for uplink communications. For example, three or four frequency bands may be configured for uplink communications. However, the UE may be limited to communications on two bands at a time (using up to two uplink transmit chains). As a result, at least some bands may not be used by a UE at any given time.

In some cases, the frequency bands used for the uplink transmit chains may be switched. A rule currently exists that defines that, when uplink transmit chain switching occurs as a result of a network command, the UE will not expect to receive a request to perform more than one switch in a single slot. Determining the duration of the slot in which the switch occurs, however, raises questions. Often, a slot duration is based on a subcarrier spacing (SCS) of the frequency band used during that slot. But when a switch occurs during a slot, it may not be clear which SCS (e.g., the SCS of the frequency band prior to the switch or the SCS of the frequency band after the switch) to apply in order to determine the slot duration (during which just one switch is to occur). The SCS of the “switching” slot may be determined based on the SCSs of the different frequency bands involved in the switch.

The question resolved by the techniques discussed herein is that when determining the SCS of the switching slot, whether to consider an SCS of deactivated carriers or carriers within dormant bandwidth parts (BWPs). For example, when more than two frequency bands are configured for uplink communications, some of the frequency bands may be deactivated carriers or carriers within dormant BWPs.

Accordingly, when a UE is indicated to switch a frequency band for an uplink transmission chain, and at least one uplink frequency band is deactivated or dormant (which may occur if the number of supported frequency bands is more than two, where the UE only has two transmit chains), the UE may determine the SCS of the slot in which the frequency switch occurs based on a rule and an equation. The equation is that the SCS of the slot is equal to the maximum SCS of each possible uplink carrier. In one option, the rule is that the candidate uplink carriers whose SCS is to be considered do not include carriers that are deactivated or that are in dormant BWPs. In another option, the rule is that the candidate uplink carriers whose SCS is to be considered do include deactivated carriers or carriers in dormant BWPs. The SCS used for the deactivated carriers or carriers associated with dormant BWPs may be given by the network in a radio resource control (RRC) message associated with each BWP.

Aspects of the disclosure are initially described in the context of wireless communications systems. Aspects of the disclosure are further illustrated by and described with reference to apparatus diagrams, system diagrams, and flowcharts that relate to techniques for frequency switching for uplink transmission for multiple bands.

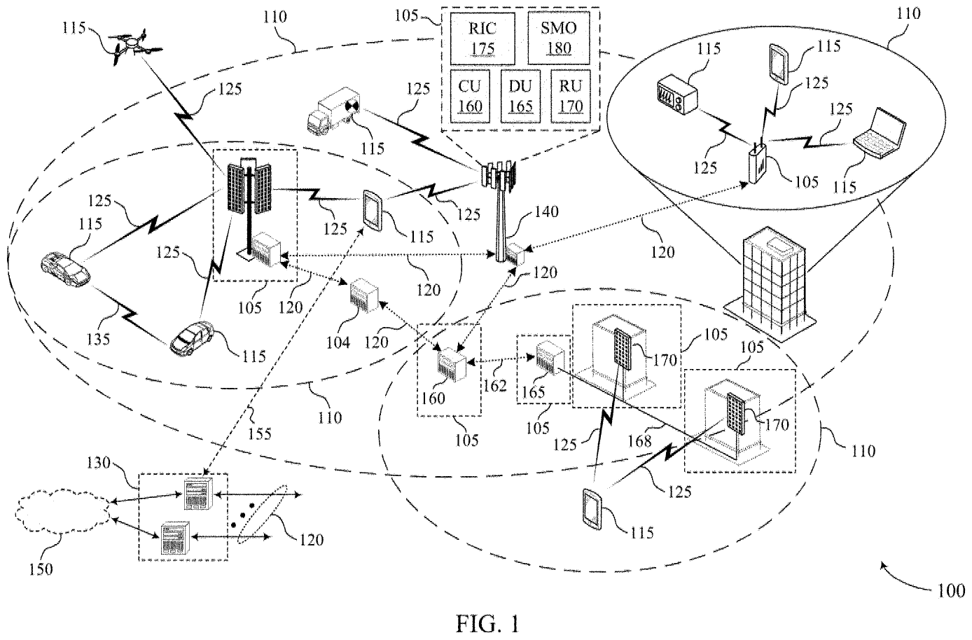

FIG. 1 illustrates an example of a wireless communications system 100 that supports techniques for frequency switching for uplink transmission for multiple bands in accordance with one or more aspects of the present disclosure. The wireless communications system 100 may include one or more network entities 105, one or more UEs 115, and a core network 130. In some aspects, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some aspects, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125.

The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE.

In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology.

Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some aspects, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some aspects, network entities 105 may communicate with one another via a backhaul communication link 120 (e.g., in accordance with an X2, Xn, or other interface protocol) either directly (e.g., directly between network entities 105) or indirectly (e.g., via a core network 130). In some aspects, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some aspects, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some aspects, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some aspects, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some aspects, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some aspects, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some aspects, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN.

Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104.

Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for frequency switching for uplink transmission for multiple bands as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some aspects, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a BWP) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some aspects, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some aspects, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some aspects, the wireless communications system 100 may include network entities 105 or UEs 115 that support concurrent communications using carriers associated with multiple carrier bandwidths. In some aspects, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include an SCS (Af) and a cyclic prefix. A carrier may be divided into one or more BWPs having the same or different numerologies. In some aspects, a UE 115 may be configured with multiple BWPs. In some aspects, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported SCS, and N_{f}may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some aspects, a frame may be divided (e.g., in the time domain) into subframes, and each subframe may be further divided into a quantity of slots. Alternatively, each frame may include a variable quantity of slots, and the quantity of slots may depend on SCS. Each slot may include a quantity of symbol periods (e.g., depending on the length of the cyclic prefix prepended to each symbol period). In some wireless communications systems 100, a slot may further be divided into multiple mini-slots associated with one or more symbols.

Excluding the cyclic prefix, each symbol period may be associated with one or more (e.g., N_{f}) sampling periods. The duration of a symbol period may depend on the SCS or frequency band of operation.

A subframe, a slot, a mini-slot, or a symbol may be the smallest scheduling unit (e.g., in the time domain) of the wireless communications system 100 and may be referred to as a transmission time interval (TTI). In some aspects, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some aspects, a network entity 105 (e.g., a base station 140, an RU 170) may be movable and therefore provide communication coverage for a moving coverage area 110. In some aspects, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some aspects, a UE 115 may be configured to support communicating directly with other UEs 115 via a device-to-device (D2D) communication link 135 (e.g., in accordance with a peer-to-peer (P2P), D2D, or sidelink protocol). In some aspects, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some aspects, one or more UEs 115 of such a group may be outside the coverage area 110 of a network entity 105 or may be otherwise unable to or not configured to receive transmissions from a network entity 105. In some aspects, groups of the UEs 115 communicating via D2D communications may support a one-to-many (1:M) system in which each UE 115 transmits to each of the other UEs 115 in the group. In some aspects, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHZ.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some aspects, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some aspects, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some aspects, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some aspects, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device.

The adjustments associated with each of the antenna elements may be defined by a beamforming weight set associated with a particular orientation (e.g., with respect to the antenna array of the transmitting device or receiving device, or with respect to some other orientation).

When a UE 115 is indicated to switch a frequency band for an uplink transmit chain, and at least one uplink frequency band is deactivated or dormant (which may occur if the quantity of supported frequency bands is more than two, but the UE 115 only has two transmit chains), the UE 115 may determine the SCS of the slot in which the frequency switch occurs based on a rule and an equation. The equation is that the SCS of the slot is equal to the maximum SCS of each possible uplink carrier. In one option, the rule is that the candidate uplink carriers whose SCS is to be considered do not include carriers that are deactivated or that are in dormant BWPs. In another option, the rule is that the candidate uplink carriers whose SCS is to be considered do include deactivated carriers or carriers in dormant BWPs. In this second example, the SCS used for the deactivated carriers or carriers associated with dormant BWPs is given by the network in an RRC message associated with each BWP.

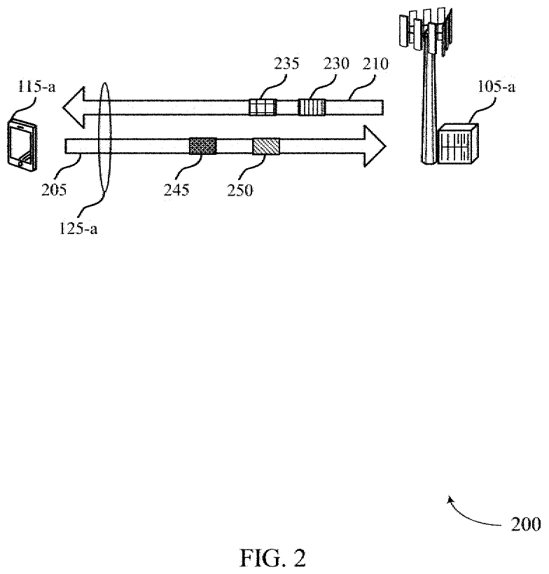

FIG. 2 illustrates an example of a wireless communication system 200 that supports techniques for frequency switching for uplink transmission for multiple bands in accordance with one or more aspects of the present disclosure. The wireless communications system 200 may implement aspects of or may be implemented by aspects of the wireless communications system 100. For example, the wireless communications system 200 includes a UE 115-a, which may be an example of a UE 115 described with respect to FIG. 1. The wireless communications system 200 also includes a network entity 105-a, which may be an example of a network entity 105 as described with respect to FIG. 1.

The network entity 105-a may communicate with the UE 115-a using a communication link 125-a, which may be an example of a communication link 125 as described herein. The communication link 125-a may be an example of an NR or LTE link between the UE 115-a and the network entity 105-a. The communication link 125-a may include a bi-directional link that enables both uplink and downlink communications. For example, the UE 115-a may transmit uplink signals 205 (e.g., uplink transmissions), such as uplink control signals or uplink data signals, to the network entity 105-a using the communication link 125-a and the network entity 105-a may transmit downlink signals 210 (e.g., downlink transmissions), such as downlink control signals or downlink data signals, to the UE 115-a using the communication link 125-a.

In some examples, the UE 115-a may communicate over two uplink transmit chains simultaneously, either in the same frequency band or in different frequency bands (e.g., in Release 16 or Release 17 of 3rd Generation Partnership Project (3GPP) of wireless communication standards). In such examples, uplink transmission switching for two frequency bands may be supported. The UE 115-a may enable simultaneous transmission of up to two uplink transmit chains on one or two frequency bands. For example, for a switched uplink (switchedUL) or a supplementary uplink (SUL) operation, the UE 115-a may transmit on one of the two frequency bands. For a dual uplink (dualUL) operation, the UE 115-a may transmit simultaneously on both frequency bands up but still up to two uplink transmit chains.

For both the switched uplink and the dual uplink operations, the UE 115-a may switch a state of the uplink transmission chains via uplink transmission chain frequency switching (e.g., dynamically, based on a trigger, periodically, and so forth). In a switched uplink operation, the UE 115-a may transmit uplink transmission chains one frequency band at a time, and may switch frequency bands by switching the frequency band for both (if two) transmission chains. In a dual uplink transmission operation, the UE 115-a may transmit two uplink transmission chains via the same band or via different frequency bands. In dual uplink transmission operation, the UE 115-a may switch between transmitting both uplink transmission chains via the same band and via different frequency bands in accordance with an uplink transmission chain frequency switch. Uplink transmission chain switching may occur before or after a switching gap.

In some cases, for uplink transmission switching, the UE 115-a may report a length of time to perform the uplink transmission switch as part of a UE capability signaling. For uplink transmission switching, the maximum frequency may be defined by a rule. For example, the rule may include that the UE 115-a may not expect to receive a request to perform more than one switch in a single slot, μ_{UL}=max (μ_{UL, 1}, μ_{UL, 2}), where the μ_{UL, 1} corresponds to the SCS of the active uplink bandwidth of one uplink carrier before a switching gap and the μ_{UL, 2} corresponds to the SCS of the active uplink BWP of the other uplink carrier after the switching gap.

In a mapping between antenna ports and uplink transmission statuses (e.g., cases) when two frequency bands are available, the uplink transmission switch may include a first case (e.g., state or status) and a second case associated with a SUL operation and a carrier aggregation first option (CA Option 1). In the first case, the quantity of uplink transmit chains may include 0T+2T corresponding to Band A and Band B, where T refers to uplink transmission chains. As such, 0T+2T refers to no uplink transmission chains on Band A (e.g., 0T) and both transmission chains on Band B (e.g., 2T) and the uplink transmission chains may not be simultaneous on different bands. The quantity of antenna ports for uplink transmission chains corresponding to Band A and B and B includes 0P+2P (e.g., zero ports for Band A and two ports for band B) or 0P+1P.

In the second case associated with a SUL operation and a carrier aggregation first option, the quantity of uplink transmission chains may be 2T+0T corresponding to Band A and Band B so that two uplink transmission chains are on Band A and no uplink transmission chains are on Band B. The quantity of antenna ports corresponding to Band A and Band B includes 2P+0P for Band A and Band B or 1P+0P for Band A and Band B.

In some aspects, simultaneous transmission of the uplink transmission chains may be supported by the frequency bands A and B. For example, in a first case of a carrier aggregation second option (CA Option 2), the quantity of uplink transmission chains may be 1T+1T corresponding to Band A and Band B so that one uplink transmission chain is supported on Band A and one simultaneous uplink transmission chain is supported on Band B. The quantity of antenna ports for this case is 1P+1P, 0P+1P, or 1P+0P, where each port can support up to one uplink transmission chain.

In a second case of the carrier aggregation option two, the quantity of uplink transmission chains may be 0T+2T corresponding to Band A and Band B so that no uplink transmission chain is supported on Band A and two uplink transmission chains are supported on Band B. The quantity of antenna ports for this case is 0P+2P or 0P+1P, where each port can support up to either one or two active uplink transmissions. In a third case of the carrier aggregation option two, the quantity of uplink transmission chains may be 2T+0T corresponding to Band A and Band B so that two uplink transmission chains are supported on Band A and no uplink transmission chain is supported on Band B. The quantity of antenna ports for this case is 2P+0P or 1P+0P, where each port can support up to either one or two active uplink transmission chains.

The UE 115-a may indicate to the network entity 105-a a capability of the UE 115-a to switch uplink transmit chains for communications on component carriers over a quantity of frequency bands. The quantity of frequency bands may be greater than two and the capability may indicate that the UE 115-a is capable of simultaneous uplink transmissions over fewer than the quantity of frequency bands. In some aspects, the quantity of frequency bands may be greater than two, such as three or four and some carriers or of the frequency bands may be deactivated or contained within dormant BWPs.

The network entity 105-a may transmit first control information 230 to the UE 115-a, and the first control information 230 may indicate a switch from communications over a first set of frequency bands to communications over a second set of frequency bands in accordance with the capability indicated capability of the UE 115-a. The network entity 105-a may transmit second control information 235 to the UE 115-a, and the second control information 235 may indicate whether the component carriers are activated or deactivated or whether the component carriers are in dormant BWPs or non-dormant BWPs. In some aspects, the first control information 230 and the second control information may be transmitted via a same control message (e.g., RRC). In some aspects, the first control information 230 and the second control information may be transmitted via different control messages.

In some aspects, the UE 115-a may perform uplink transmission switching for multiple bands, such as for more than two bands. The UE 115-a may enable simultaneous transmission of up to two transmit chains on one or two bands from the multiple bands (e.g., from the three or four bands). For a switched uplink (e.g., switchedUL) operation and for a SUL operation, the UE 115-a may transmit only on one band from the multiple bands. For dual uplink (e.g., dualUL), the UE 115-a may transmit simultaneously on one or two bands (but still up to two uplink transmit chains) from the multiple bands (e.g., three or four bands).

The SCS considered for the slot duration for uplink transmission switching may be specified by a rule. For example, the UE 115-a may not perform more than one uplink transmission switching within a reference slot, based on μ_{UL}=max(μ_{UL, 1}, μ_{UL, 2}, μ_{UL, 3}) in case of three bands, μ_{UL}=max(μ_{UL, 1}, μ_{UL, 2}, μ_{UL, 3}, μ_{UL, 4}) in case of four bands, where μ_{UL, 1}, μ_{UL, 2}, μ_{UL, 3}, μ_{UL, 4} are SCSs of active uplink BWPs of the bands in a band combination. In some aspects, multiple intra-band carriers may be in one band. For example, there may be two consecutive intra-band carriers in one band, μ_{UL, 1}=max(μ_{UL, 1-1}, μ_{UL, 1-2}), where μ_{UL, 1-1} and μ_{UL, 1-2} are SCSs of active uplink BWPs of the carriers in the band.

The network entity 105-a may receive an indication, from the UE 115-a, of a capability of the UE 115-a to switch uplink transmit chains for communications on component carriers over a quantity of frequency bands. The network entity 105-a may receive the first uplink transmit chain 245 and the second uplink transmit chain 250. For example, the first uplink transmit chain 245 and the second uplink transmit chain 250 on the active uplink BWPs of the carriers of the indicated bands.

No uplink transmission may occur on a carrier when the carrier is deactivated or dormant (e.g., in a secondary cell (SCell)). When uplink transmission switching occurs over two carriers (e.g., in Release 16 and Release 17), once the SCell is deactivated, the uplink transmission switching over two carriers may not occur. However, when the uplink transmission switching occurs over three or more bands, even if one or more carriers are deactivated or dormant, the uplink transmission switching may continue over the active or non-dormant carriers in the three or more bands. The reference SCSs may be determined using the techniques and rules described herein when one or more carriers involved in the uplink transmission switching for three or more bands is deactivated or dormant.

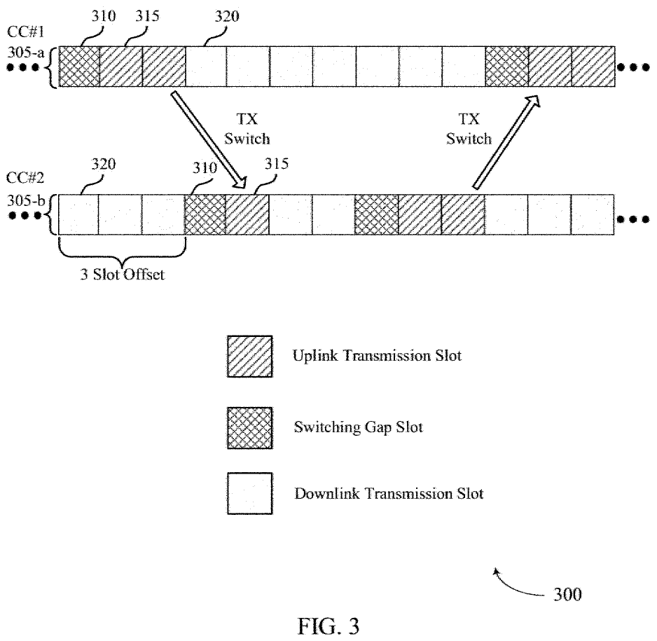

FIG. 3 illustrates an example of an uplink transmission switch 300 that supports techniques for frequency switching for uplink transmission for multiple bands in accordance with one or more aspects of the present disclosure. The uplink transmission switch 300 may correspond to the first case of carrier aggregation option 1, discussed with respect to FIG. 2, where the quantity of uplink transmit chains includes no uplink transmissions on a first band and two uplink transmission on a second uplink transmissions (e.g., 0T+2T) or vice versa. The uplink transmissions may not be simultaneous on different bands. The uplink transmit chains cannot switch to a deactivated or dormant carrier, but if there is another carrier that is not deactivated or dormant, then the transmit chains may be switched to that carrier.

A first component carrier 305-a and a second component carrier 305-b are indicative of uplink transmissions in the time domain, where each component carrier 305 includes a set of slots (e.g., time resource). Although the component carriers 305 are described with respect to a set of slots, the component carriers 305 may apply to any time resource (e.g., symbol), and may include fewer or greater quantity of slots (as indicated by the ellipses). The component carriers 305 may include one or more of switching gap slots 310, uplink transmission slots 315, and downlink transmission slots 320.

The first component carrier 305-a may include transmissions over a first component carrier (CC#1) and the second component carrier 305-b may include transmissions over a second component carrier (CC#2), and the component carriers 305 may enable the UE 115 to dynamically switch between two component carriers (e.g., frequency bands) for uplink transmissions. One or both uplink transmit chains may be capable of switching between the two component carriers. The uplink transmissions may occur during different time slots or in different component carriers such that power and antenna resources of the UE 115 may be efficiently utilized in each of the configuration transactions.

The first component carrier 305-a includes a switching gap slots 310 in first slot while the second component carrier 305-b includes a downlink transmission slot 320 during the same time slot. A switching gap slot 310 may occur before the transition or switch from a downlink transmission slot 320 to an uplink transmission slot 315. In some aspects, switching uplink transmissions from the first carrier of the first component carrier 305-a to the second carrier in the second component carrier 305-b may not occur before a predetermined offset. For example, the offset period may be one slot, three slots (as shown), five slots, and so forth. After the three slot offset in the second component carrier 305-b, the switch may occur so that the fourth time slot in the second component carrier 305-b is the switching gap slot 310 followed by the uplink transmission slot 315. Accordingly, both uplink transmit chains may be transmitted during the uplink transmission slot 315 on the second component carrier.

The uplink transmission switching may occur multiple times in a component carrier 305. As shown, the uplink transmission switching takes place based on the offset before switching (e.g., of at least three slots), and the switching gap slot 310 may occur before switching from downlink transmissions to uplink transmissions on the component carrier. The switching of the two uplink transmit chains between the first component carrier and second component carrier may improve uplink throughput (e.g., of approximately 66.7% when bandwidth is the same for the component carriers). In some aspects, two uplink transmission slots may be expected to occur during the same slot if no slot offset is applied, and a UE 115 may be configured to support one transmit chain on each component carrier or up to two transmit chains on one component carrier, limiting the uplink throughput.

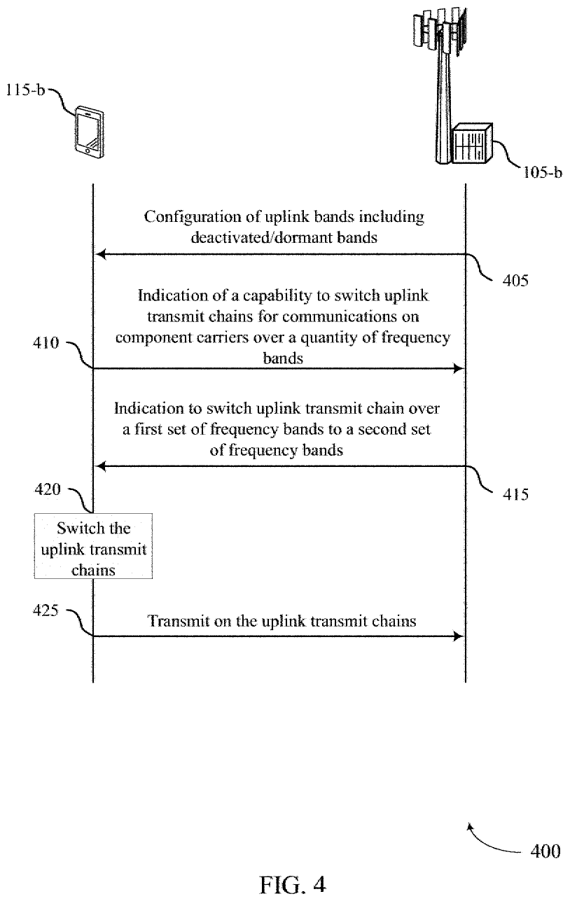

FIG. 4 illustrates an example of a process flow 400 that supports techniques for frequency switching for uplink transmission for multiple bands in accordance with one or more aspects of the present disclosure. The process flow 400 may implement aspects of or may be implemented by aspects of the wireless communications system 100 or the wireless communications system 200. For example, the process flow 400 may include a UE 115-b, which may be an example of a UE 115 as described herein. The process flow 400 may include a network entity 105-b, which may be an example of a network entity 105 as described herein. In the following description of the process flow 400, the operations performed by the network entity 105-b and the UE 115-b may be performed in different orders or at different times than the exemplary order shown. Some operations may also be omitted from the process flow 400, or other operations may be added to the process flow 400. Further, while operations in the process flow 400 are illustrated as being performed by the network entity 105-b and the UE 115-b, the examples herein are not to be construed as limiting, as the described features may be associated with any quantity of different devices.

In some aspects, at 405, the network entity 105-b may transmit a configuration of uplink bands, including an indication of any deactivated carriers or dormant BWPs. For example, the network entity 105-b may transmit information indicating which component carriers are activated or deactivated. In some aspects, the information may indicate whether the component carriers are in dormant BWPs or non-dormant BWPs.

At 410, the UE 115-b may transmit an indication of a capability to switch uplink transmit chains for communications on component carriers over a quantity of frequency bands. The quantity of frequency bands may be greater than two and the capability may indicate that the UE 115-b is capable of simultaneous uplink transmissions over fewer than the quantity of frequency bands. In some aspects, the quantity of frequency bands may be three or four bands.

At 415, the network entity 105-b may transmit an indication to switch the uplink transmit chains over a first set of frequency bands to a second set of frequency bands, where the first set and the second set are different. In some aspects, the first set of frequency bands is a single frequency band over which the UE 115-b may communicate using a first uplink transmit chain and a second uplink transmit chain. The second set of frequency bands may include a first frequency band over which the UE 115-b communicates using the first uplink transmit chain and a second frequency band over which the UE 115-b communicates using the second uplink transmit chain.

In some aspects, the first set of frequency bands includes a first frequency band over which the UE 115-b communicates using a first uplink transmit chain and a second frequency band over which the UE 115-b communicates using a second uplink transmit chain, and the second set of frequency bands is a single frequency band over which the UE 115-b communicates using both the first uplink transmit chain and the second uplink transmit chain. In some aspects, the first set of frequency bands is a first single frequency band over which the UE 115-b may communicate using a first uplink transmit chain and a second uplink transmit chain, and the second set of frequency bands is a second single frequency band over which the UE 115-b may communicate using both the first uplink transmit chain and the second uplink transmit chain.

In some aspects, the first set of frequency bands includes a first frequency band over which the UE 115-b communicates using a first uplink transmit chain and a second frequency band over which the UE 115-b communicates using a second uplink transmit chain, and the second set of frequency bands includes a third frequency band over which the UE 115-b communicates using the first uplink transmit chain and a fourth frequency band over which the UE 115-b communicates using the second uplink transmit chain. In some aspects, the capability from the UE 115-b may indicate that the UE 115-b is capable of simultaneous uplink transmissions over a maximum of two frequency bands using two uplink transmit chains.

At 420, the UE 115-b may switch the uplink transmit chains in accordance with the indication from the network entity 105-b. At 425, the UE 115-b may transmit on the uplink transmit chains. When uplink carriers in a band are deactivated, for example, for uplink transmissions over more than two bands, determining the SCS of the switching slot may be defined based on a rule. An SCS of a slot in which at least a portion of the switch occurs is based on a rule that defines whether candidate SCS values are associated with deactivated component carriers or component carriers that are in dormant BWPs. The SCS of the slot may be determined in accordance with the rule, where the rule defines that the SCS of the slot is based on a maximum numerology of the candidate SCS values, and where all of the candidate SCS values are associated with activated component carriers or component carriers that are in non-dormant BWPs. The UE 115-b may determine the SCS of the slot in accordance with the rule, where the rule defines that the SCS of the slot is based on a maximum numerology of the candidate SCS values, and where all of the candidate SCS values are associated with activated component carriers or component carriers that are in non-dormant BWPs. In some aspects, the SCS values are associated with a combination of activated component carriers or component carriers that are in non-dormant BWPs and the deactivated component carriers or the component carriers that are in dormant BWPs. The SCS values may be associated with the deactivated component carriers or the component carriers that are in dormant BWPs may be based on a first active uplink BWP identification associated with respective ones of the deactivated component carriers or dormant BWPs.

In a first case for when uplink carriers in a band is deactivated, the rule may define that the SCS for uplink carriers in the band may excluded from the determination of μ_{UL}. The μ_{UL}=max(μ_{UL, 1}, μ_{UL, 2}, μ_{UL, 3}, μ_{UL, 4}) in the case of four bands, where μ_{UL, 1}, μ_{UL, 2}, μ_{UL, 3}, μ_{UL, 4} are SCSs of active uplink BWPs of activated carriers or cells in the bands in a band combination. In a second case when uplink carriers in a band is deactivated, the rule may define that the SCS for the uplink carriers in the band is still included in the determination of μ_{UL}. The μ_{UL}=max(μ_{UL, 1}, μ_{UL, 2}, μ_{UL, 3}, μ_{UL, 4}) in case of four bands, where μ_{UL, 1}, μ_{UL, 2}, μ_{UL, 3}, μ_{UL, 4} are SCSs of active UL BWPs of the carriers or cells being activated, and SCSs of uplink BWPs configured with a first active uplink BWP identification (firstActive UplinkBWP-Id) of the carriers or cells being deactivated, in the bands in the band combination.

In a third case, when the active uplink BWP of the uplink carriers in a band is a dormant BWP, the rule may define that the SCS for the UL carriers in the band is excluded from the determination of μ_{UL}. The μ_{UL}=max (μ_{UL, 1}, μ_{UL, 2}, μ_{UL, 3}, μ_{UL, 4}) in case of four bands, where μ_{UL, 1}, μ_{UL, 2}, μ_{UL, 3}, μ_{UL, 4} are SCSs of active uplink BWPs of which are not dormant BWPs in the bands in the band combination. In a fourth case, when the active uplink BWP of the uplink carriers in a band is a dormant BWP, the rule may define that the SCS for the uplink carriers in the band is still included in the determination of μ_{UL}. The μ_{UL}=max(μ_{UL, 1}, μ_{UL, 2}, μ_{UL, 3}, μ_{UL, 4}) in case of four bands, where μ_{UL, 1}, μ_{UL, 2}, μ_{UL, 3}, μ_{UL, 4} are SCSs of active uplink BWPs of the carriers or cells where active BWPs are not dormant BWPs, and SCSs of uplink BWPs configured with firstActive UplinkBWP-Id of the carriers or cells where active BWPs are dormant BWPs in the bands in the band combination.

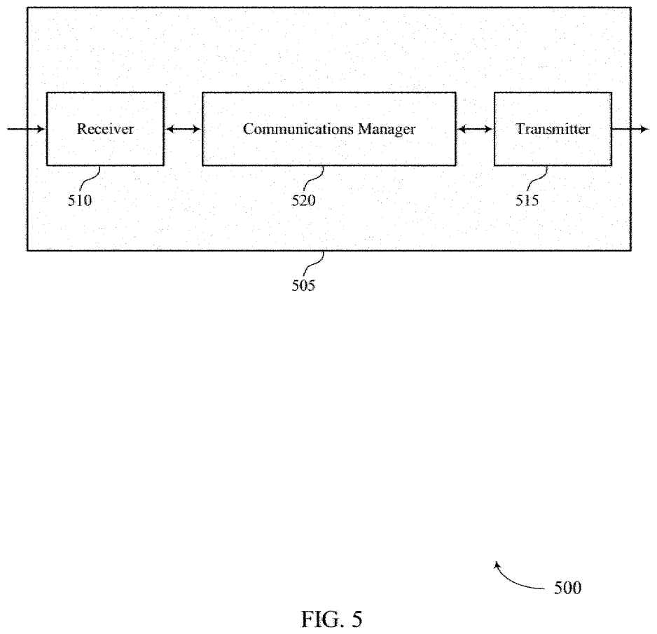

FIG. 5 illustrates a block diagram 500 of a device 505 that supports techniques for frequency switching for uplink transmission for a set of multiple bands in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for frequency switching for uplink transmission for a set of multiple bands). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for frequency switching for uplink transmission for a set of multiple bands). In some aspects, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of techniques for frequency switching for uplink transmission for a set of multiple bands as described herein. For example, the communications manager 520, the receiver 510, the transmitter 515, or various combinations or components thereof may support a method for performing one or more of the functions described herein.

In some aspects, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some aspects, a processor and memory coupled with the processor may be configured to perform one or more of the functions described herein (e.g., by executing, by the processor, instructions stored in the memory).

Additionally, or alternatively, in some aspects, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some aspects, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a first node in accordance with examples as disclosed herein. For example, the communications manager 520 may be configured as or otherwise support a means for transmitting an indication of a capability of the first network node to switch uplink transmit chains for communications on component carriers over a quantity of frequency bands, where the quantity of frequency bands is greater than two and where the capability indicates that the first network node is capable of simultaneous uplink transmissions over fewer than the quantity of frequency bands. The communications manager 520 may be configured as or otherwise support a means for receiving control information that indicates a switch from communications over a first set of frequency bands to communications over a second set of frequency bands in accordance with the capability, the second set and the first set being different. The communications manager 520 may be configured as or otherwise support a means for switching the uplink transmit chains of the first network node in accordance with the control information, where a SCS of a slot in which at least a portion of the switch occurs is based on a rule that defines whether candidate SCS values are associated with deactivated component carriers or component carriers that are in dormant BWPs.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for efficiently increasing uplink throughput using uplink transmission switching while considering deactivated carriers or dormant BWPs.

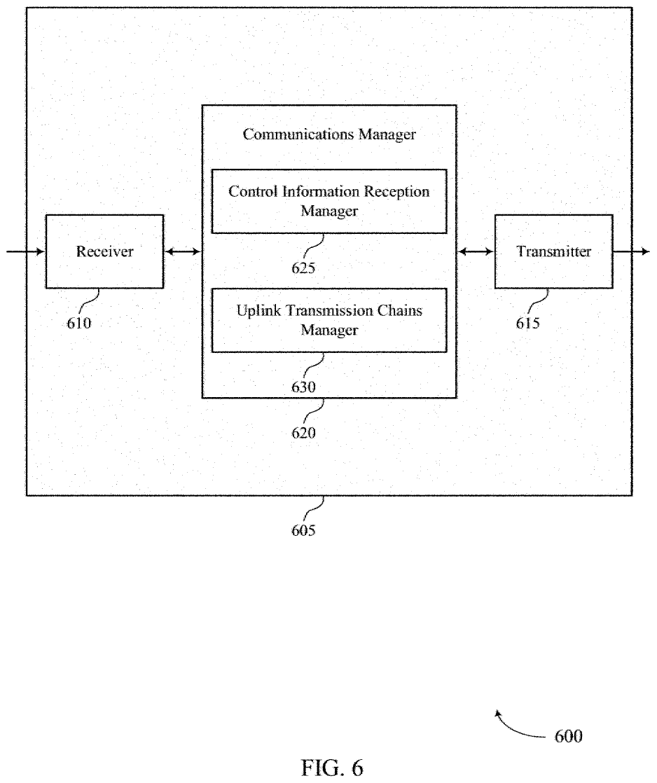

FIG. 6 illustrates a block diagram 600 of a device 605 that supports techniques for frequency switching for uplink transmission for a set of multiple bands in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for frequency switching for uplink transmission for a set of multiple bands). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for frequency switching for uplink transmission for a set of multiple bands). In some aspects, the transmitter 615 may be co-located with a receiver 610 in a transceiver module. The transmitter 615 may utilize a single antenna or a set of multiple antennas.

The device 605, or various components thereof, may be an example of means for performing various aspects of techniques for frequency switching for uplink transmission for a set of multiple bands as described herein. For example, the communications manager 620 may include a control information reception manager 625 an uplink transmit chains manager 630, or any combination thereof. The communications manager 620 may be an example of aspects of a communications manager 520 as described herein. In some aspects, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a first node in accordance with examples as disclosed herein. The control information reception manager 625 may be configured as or otherwise support a means for transmitting an indication of a capability of the first network node to switch uplink transmit chains for communications on component carriers over a quantity of frequency bands, where the quantity of frequency bands is greater than two and where the capability indicates that the first network node is capable of simultaneous uplink transmissions over fewer than the quantity of frequency bands. The uplink transmit chains manager 630 may be configured as or otherwise support a means for receiving control information that indicates a switch from communications over a first set of frequency bands to communications over a second set of frequency bands in accordance with the capability, the second set and the first set being different. The uplink transmit chains manager 630 may be configured as or otherwise support a means for switching the uplink transmit chains of the first network node in accordance with the control information, where a SCS of a slot in which at least a portion of the switch occurs is based on a rule that defines whether candidate SCS values are associated with deactivated component carriers or component carriers that are in dormant BWPs.

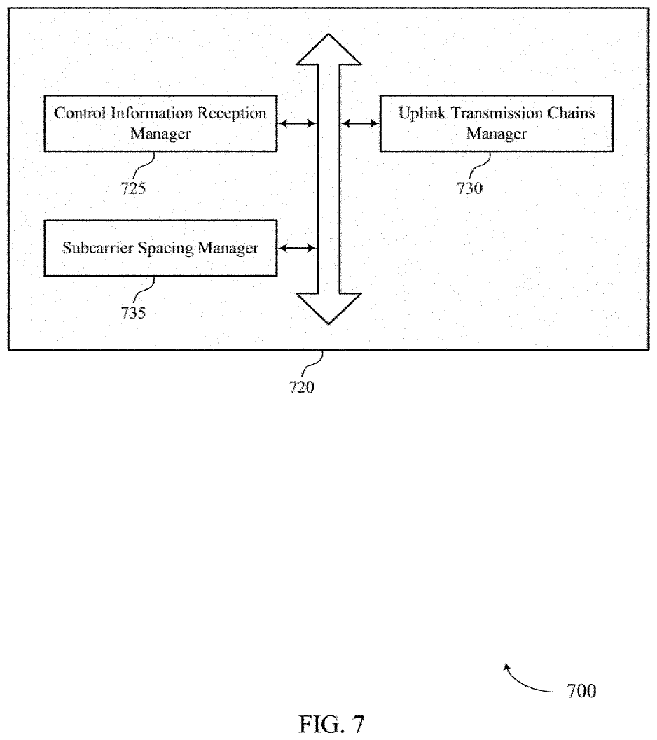

FIG. 7 illustrates a block diagram 700 of a communications manager 720 that supports techniques for frequency switching for uplink transmission for a set of multiple bands in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for frequency switching for uplink transmission for a set of multiple bands as described herein. For example, the communications manager 720 may include a control information reception manager 725, an uplink transmit chains manager 730, a SCS manager 735, or any combination thereof. Each of these components may communicate, directly or indirectly, with one another (e.g., via one or more buses).

The communications manager 720 may support wireless communications at a first node in accordance with examples as disclosed herein. The control information reception manager 725 may be configured as or otherwise support a means for transmitting an indication of a capability of the first network node to switch uplink transmit chains for communications on component carriers over a quantity of frequency bands, where the quantity of frequency bands is greater than two and where the capability indicates that the first network node is capable of simultaneous uplink transmissions over fewer than the quantity of frequency bands. The uplink transmit chains manager 730 may be configured as or otherwise support a means for receiving control information that indicates a switch from communications over a first set of frequency bands to communications over a second set of frequency bands in accordance with the capability, the second set and the first set being different. In some aspects, the uplink transmit chains manager 730 may be configured as or otherwise support a means for switching the uplink transmit chains of the first network node in accordance with the control information, where a SCS of a slot in which at least a portion of the switch occurs is based on a rule that defines whether candidate SCS values are associated with deactivated component carriers or component carriers that are in dormant BWPs.

In some aspects, the SCS manager 735 may be configured as or otherwise support a means for determining the SCS of the slot in accordance with the rule, where the rule defines that the SCS of the slot is based on a maximum numerology of the candidate SCS values, and where all of the candidate SCS values are associated with activated component carriers or component carriers that are in non-dormant BWPs.

In some aspects, the SCS manager 735 may be configured as or otherwise support a means for determining the SCS of the slot in accordance with the rule, where the rule defines that the SCS of the slot is based on a maximum numerology of the candidate SCS values, and where the candidate SCS values are associated with a combination of activated component carriers or component carriers that are in non-dormant BWPs and the deactivated component carriers or the component carriers that are in dormant BWPs.

In some aspects, the candidate SCS values associated with the deactivated component carriers or the component carriers that are in dormant BWPs are based on a first active uplink BWP identification associated with respective ones of the deactivated component carriers or dormant BWPs.

In some aspects, the quantity of frequency bands is three or four.

In some aspects, the capability indicates that the first network node is capable of simultaneous uplink transmissions over a maximum of two frequency bands using two uplink transmit chains.

In some aspects, the first set of frequency bands is a single frequency band over which the first network node communicates using a first uplink transmit chain and a second uplink transmit chain. In some aspects, the second set of frequency bands includes a first frequency band over which the first network node communicates using the first uplink transmit chain and a second frequency band over which the first network node communicates using the second uplink transmit chain.

In some aspects, the first set of frequency bands includes a first frequency band over which the first network node communicates using a first uplink transmit chain and a second frequency band over which the first network node communicates using a second uplink transmit chain. In some aspects, the second set of frequency bands is a single frequency band over which the first network node communicates using both the first uplink transmit chain and the second uplink transmit chain.

In some aspects, the first set of frequency bands is a first single frequency band over which the first network node communicates using a first uplink transmit chain and a second uplink transmit chain. In some aspects, the second set of frequency bands is a second single frequency band over which the first network node communicates using both the first uplink transmit chain and the second uplink transmit chain.

In some aspects, the first set of frequency bands includes a first frequency band over which the first network node communicates using a first uplink transmit chain and a second frequency band over which the first network node communicates using a second uplink transmit chain. In some aspects, the second set of frequency bands includes a third frequency band over which the first network node communicates using the first uplink transmit chain and a fourth frequency band over which the first network node communicates using the second uplink transmit chain.

In some aspects, the control information indicates whether the component carriers are activated or deactivated.

In some aspects, the control information indicates whether the component carriers are in dormant BWPs or non-dormant BWPs.

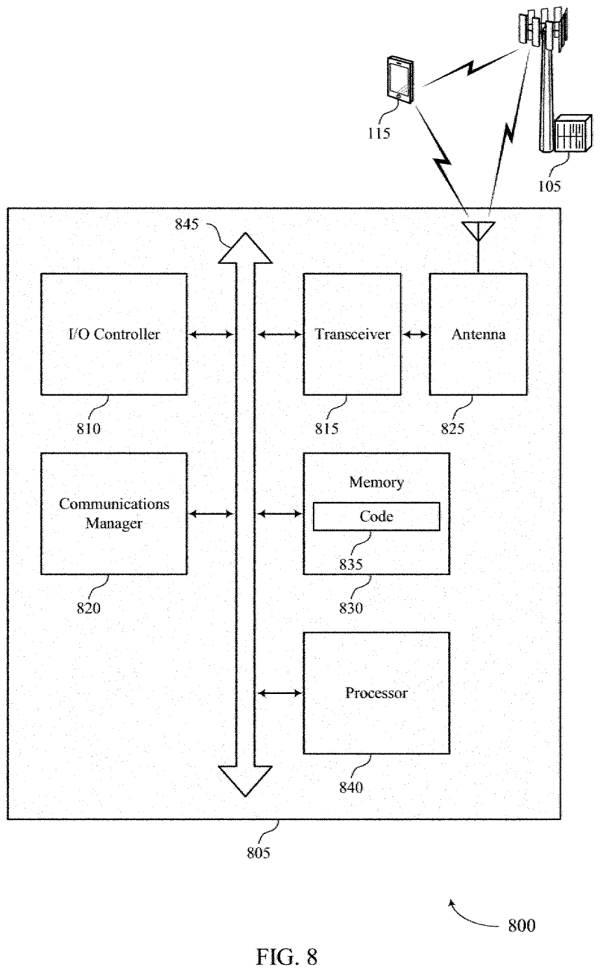

FIG. 8 illustrates a diagram of a system 800 including a device 805 that supports techniques for frequency switching for uplink transmission for a set of multiple bands in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting techniques for frequency switching for uplink transmission for a set of multiple bands). For example, the device 805 or a component of the device 805 may include a processor 840 and memory 830 coupled with or to the processor 840, the processor 840 and memory 830 configured to perform various functions described herein.

The communications manager 820 may support wireless communications at a first node in accordance with examples as disclosed herein. For example, the communications manager 820 may be configured as or otherwise support a means for transmitting an indication of a capability of the first network node to switch uplink transmit chains for communications on component carriers over a quantity of frequency bands, where the quantity of frequency bands is greater than two and where the capability indicates that the first network node is capable of simultaneous uplink transmissions over fewer than the quantity of frequency bands. The communications manager 820 may be configured as or otherwise support a means for receiving control information that indicates a switch from communications over a first set of frequency bands to communications over a second set of frequency bands in accordance with the capability, the second set and the first set being different. The communications manager 820 may be configured as or otherwise support a means for switching the uplink transmit chains of the first network node in accordance with the control information, where a SCS of a slot in which at least a portion of the switch occurs is based on a rule that defines whether candidate SCS values are associated with deactivated component carriers or component carriers that are in dormant BWPs.

By including or configuring the communications manager 820 in accordance with examples as described herein, the device 805 may support techniques for efficiently increasing uplink throughput using uplink transmission switching while considering deactivated carriers or dormant BWPs. In some aspects, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some aspects, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of techniques for frequency switching for uplink transmission for a set of multiple bands as described herein, or the processor 840 and the memory 830 may be otherwise configured to perform or support such operations.

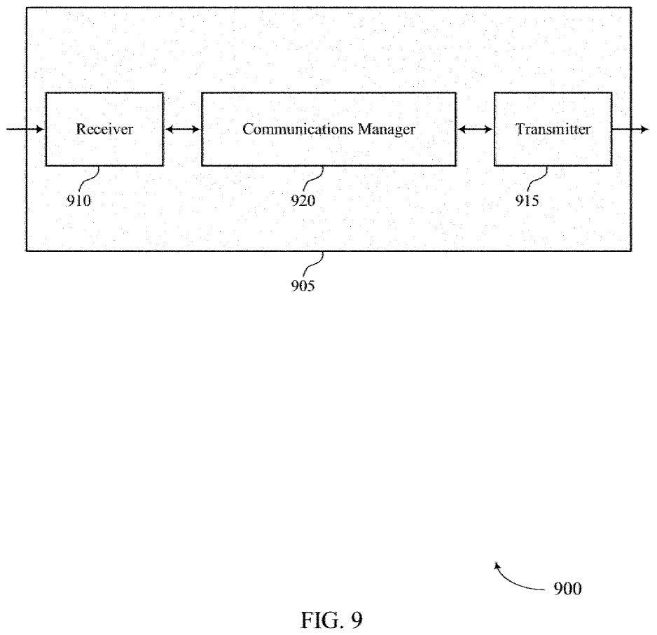

FIG. 9 illustrates a block diagram 900 of a device 905 that supports techniques for frequency switching for uplink transmission for a set of multiple bands in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some aspects, the receiver 910 may support obtaining information by receiving signals via one or more antennas.

Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some aspects, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of techniques for frequency switching for uplink transmission for a set of multiple bands as described herein. For example, the communications manager 920, the receiver 910, the transmitter 915, or various combinations or components thereof may support a method for performing one or more of the functions described herein.

In some aspects, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some aspects, a processor and memory coupled with the processor may be configured to perform one or more of the functions described herein (e.g., by executing, by the processor, instructions stored in the memory).

Additionally, or alternatively, in some aspects, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some aspects, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a first node in accordance with examples as disclosed herein. For example, the communications manager 920 may be configured as or otherwise support a means for receiving, from a second network node, an indication of a capability of the second network node to switch uplink transmit chains for communications on component carriers over a quantity of frequency bands, where the quantity of frequency bands is greater than two and where the capability indicates that the second network node is capable of simultaneous uplink transmissions over fewer than the quantity of frequency bands. The communications manager 920 may be configured as or otherwise support a means for transmitting, to the second network node, control information that indicates a switch from communications over a first set of frequency bands to communications over a second set of frequency bands in accordance with the capability, the second set and the first set being different. The communications manager 920 may be configured as or otherwise support a means for switching the uplink transmit chains of the second network node in accordance with the control information, where a SCS of a slot in which at least a portion of the switch occurs is based on a rule that defines whether candidate SCS values are associated with deactivated component carriers or component carriers that are in dormant BWPs. The communications manager 920 may be configured as or otherwise support a means for refraining from transmitting second control information that indicates a second switch from communications over the second set of frequency bands to communications over the first set of frequency bands or a third set of frequency bands during the slot.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for efficiently increasing uplink throughput using uplink transmission switching while considering deactivated carriers or dormant BWPs.

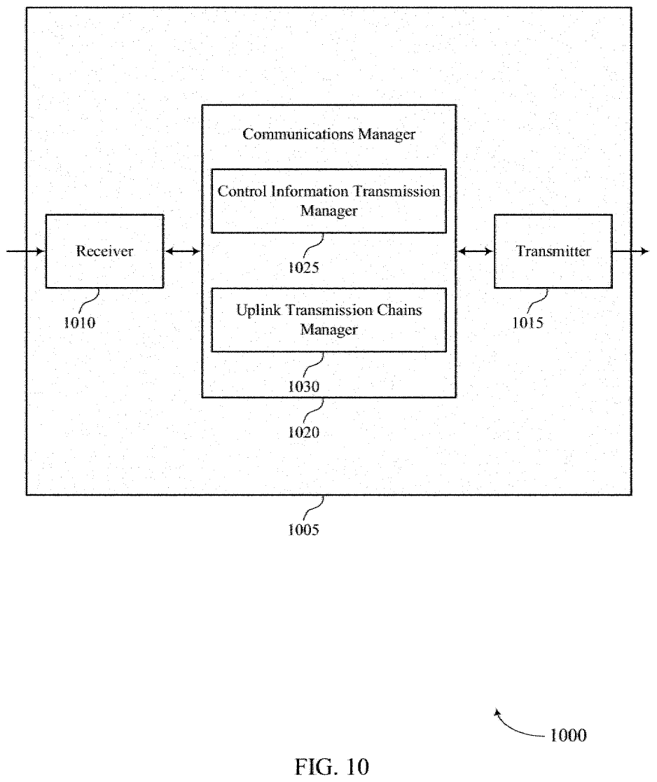

FIG. 10 illustrates a block diagram 1000 of a device 1005 that supports techniques for frequency switching for uplink transmission for a set of multiple bands in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some aspects, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some aspects, the transmitter 1015 and the receiver 1010 may be co-located in a transceiver, which may include or be coupled with a modem.

The device 1005, or various components thereof, may be an example of means for performing various aspects of techniques for frequency switching for uplink transmission for a set of multiple bands as described herein. For example, the communications manager 1020 may include a control information transmission manager 1025 an uplink transmit chains manager 1030, or any combination thereof. The communications manager 1020 may be an example of aspects of a communications manager 920 as described herein. In some aspects, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a first node in accordance with examples as disclosed herein. The control information transmission manager 1025 may be configured as or otherwise support a means for receiving, from a second network node, an indication of a capability of the second network node to switch uplink transmit chains for communications on component carriers over a quantity of frequency bands, where the quantity of frequency bands is greater than two and where the capability indicates that the second network node is capable of simultaneous uplink transmissions over fewer than the quantity of frequency bands. The uplink transmit chains manager 1030 may be configured as or otherwise support a means for transmitting, to the second network node, control information that indicates a switch from communications over a first set of frequency bands to communications over a second set of frequency bands in accordance with the capability, the second set and the first set being different. The control information transmission manager 1025 may be configured as or otherwise support a means for switching the uplink transmit chains of the second network node in accordance with the control information, where a SCS of a slot in which at least a portion of the switch occurs is based on a rule that defines whether candidate SCS values are associated with deactivated component carriers or component carriers that are in dormant BWPs. The control information transmission manager 1025 may be configured as or otherwise support a means for refraining from transmitting second control information that indicates a second switch from communications over the second set of frequency bands to communications over the first set of frequency bands or a third set of frequency bands during the slot.

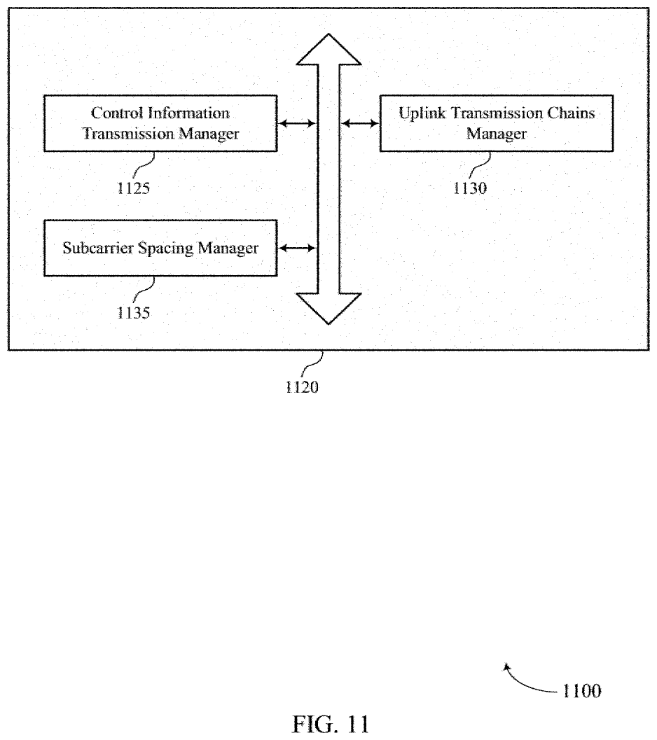

FIG. 11 illustrates a block diagram 1100 of a communications manager 1120 that supports techniques for frequency switching for uplink transmission for a set of multiple bands in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for frequency switching for uplink transmission for a set of multiple bands as described herein. For example, the communications manager 1120 may include a control information transmission manager 1125, an uplink transmit chains manager 1130, a SCS manager 1135, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications at a first node in accordance with examples as disclosed herein. The control information transmission manager 1125 may be configured as or otherwise support a means for receiving, from a second network node, an indication of a capability of the second network node to switch uplink transmit chains for communications on component carriers over a quantity of frequency bands, where the quantity of frequency bands is greater than two and where the capability indicates that the second network node is capable of simultaneous uplink transmissions over fewer than the quantity of frequency bands. The uplink transmit chains manager 1130 may be configured as or otherwise support a means for transmitting, to the second network node, control information that indicates a switch from communications over a first set of frequency bands to communications over a second set of frequency bands in accordance with the capability, the second set and the first set being different. In some aspects, the control information transmission manager 1125 may be configured as or otherwise support a means for switching the uplink transmit chains of the second network node in accordance with the control information, where a SCS of a slot in which at least a portion of the switch occurs is based on a rule that defines whether candidate SCS values are associated with deactivated component carriers or component carriers that are in dormant BWPs. In some aspects, the control information transmission manager 1125 may be configured as or otherwise support a means for refraining from transmitting second control information that indicates a second switch from communications over the second set of frequency bands to communications over the first set of frequency bands or a third set of frequency bands during the slot.

In some aspects, the SCS manager 1135 may be configured as or otherwise support a means for determining the SCS of the slot in accordance with the rule, where the rule defines that the SCS of the slot is based on a maximum numerology of the candidate SCS values, and where all of the candidate SCS values are associated with activated component carriers or component carriers that are in non-dormant BWPs.

In some aspects, the SCS manager 1135 may be configured as or otherwise support a means for determining the SCS of the slot in accordance with the rule, where the rule defines that the SCS of the slot is based on a maximum numerology of the candidate SCS values, and where the candidate SCS values are associated with a combination of activated component carriers or component carriers that are in non-dormant BWPs and the deactivated component carriers or the component carriers that are in dormant BWPs.

In some aspects, the candidate SCS values associated with the deactivated component carriers or the component carriers that are in dormant BWPs are based on a first active uplink BWP identification associated with respective ones of the deactivated component carriers or dormant BWPs.

In some aspects, the quantity of frequency bands is three or four.

In some aspects, the capability indicates that the second network node is capable of simultaneous uplink transmissions over a maximum of two frequency bands using two uplink transmit chains.

In some aspects, the first set of frequency bands is a single frequency band over which the second network node communicates using a first uplink transmit chain and a second uplink transmit chain. In some aspects, the second set of frequency bands includes a first frequency band over which the second network node communicates using the first uplink transmit chain and a second frequency band over which the second network node communicates using the second uplink transmit chain.

In some aspects, the first set of frequency bands includes a first frequency band over which the second network node communicates using a first uplink transmit chain and a second frequency band over which the second network node communicates using a second uplink transmit chain. In some aspects, the second set of frequency bands is a single frequency band over which the second network node communicates using both the first uplink transmit chain and the second uplink transmit chain.

In some aspects, the first set of frequency bands is a first single frequency band over which the second network node communicates using a first uplink transmit chain and a second uplink transmit chain. In some aspects, the second set of frequency bands is a second single frequency band over which the second network node communicates using both the first uplink transmit chain and the second uplink transmit chain.

In some aspects, the first set of frequency bands includes a first frequency band over which the second network node communicates using a first uplink transmit chain and a second frequency band over which the second network node communicates using a second uplink transmit chain. In some aspects, the second set of frequency bands includes a third frequency band over which the second network node communicates using the first uplink transmit chain and a fourth frequency band over which the second network node communicates using the second uplink transmit chain.

In some aspects, the control information indicates whether the component carriers are activated or deactivated.

In some aspects, the control information indicates whether the component carriers are in dormant BWPs or non-dormant BWPs.

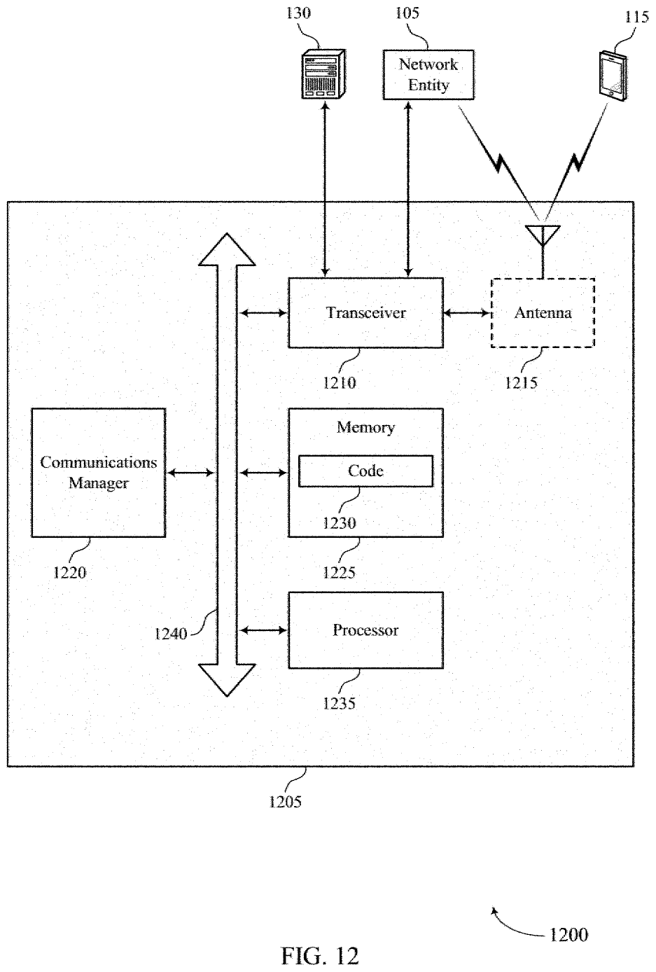

FIG. 12 illustrates a diagram of a system 1200 including a device 1205 that supports techniques for frequency switching for uplink transmission for a set of multiple bands in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some aspects, the transceiver 1210 may include a wired transceiver and may communicate bi-directionally with another wired transceiver. Additionally, or alternatively, in some aspects, the transceiver 1210 may include a wireless transceiver and may communicate bi-directionally with another wireless transceiver. In some aspects, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some aspects, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting techniques for frequency switching for uplink transmission for a set of multiple bands). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some aspects, a bus 1240 may support communications of (e.g., within) a protocol layer of a protocol stack. In some aspects, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some aspects, the communications manager 1220 may manage aspects of communications with a core network 130 (e.g., via one or more wired or wireless backhaul links). For example, the communications manager 1220 may manage the transfer of data communications for client devices, such as one or more UEs 115. In some aspects, the communications manager 1220 may manage communications with other network entities 105, and may include a controller or scheduler for controlling communications with UEs 115 in cooperation with other network entities 105. In some aspects, the communications manager 1220 may support an X2 interface within an LTE/LTE-A wireless communications network technology to provide communication between network entities 105.

The communications manager 1220 may support wireless communications at a first node in accordance with examples as disclosed herein. For example, the communications manager 1220 may be configured as or otherwise support a means for receiving, from a second network node, an indication of a capability of the second network node to switch uplink transmit chains for communications on component carriers over a quantity of frequency bands, where the quantity of frequency bands is greater than two and where the capability indicates that the second network node is capable of simultaneous uplink transmissions over fewer than the quantity of frequency bands. The communications manager 1220 may be configured as or otherwise support a means for transmitting, to the second network node, control information that indicates a switch from communications over a first set of frequency bands to communications over a second set of frequency bands in accordance with the capability, the second set and the first set being different. The communications manager 1220 may be configured as or otherwise support a means for switching the uplink transmit chains of the second network node in accordance with the control information, where a SCS of a slot in which at least a portion of the switch occurs is based on a rule that defines whether candidate SCS values are associated with deactivated component carriers or component carriers that are in dormant BWPs. The communications manager 1220 may be configured as or otherwise support a means for refraining from transmitting second control information that indicates a second switch from communications over the second set of frequency bands to communications over the first set of frequency bands or a third set of frequency bands during the slot.

By including or configuring the communications manager 1220 in accordance with examples as described herein, the device 1205 may support techniques for efficiently increasing uplink throughput using uplink transmission switching while considering deactivated carriers or dormant BWPs.

In some aspects, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some aspects, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of techniques for frequency switching for uplink transmission for a set of multiple bands as described herein, or the processor 1235 and the memory 1225 may be otherwise configured to perform or support such operations.

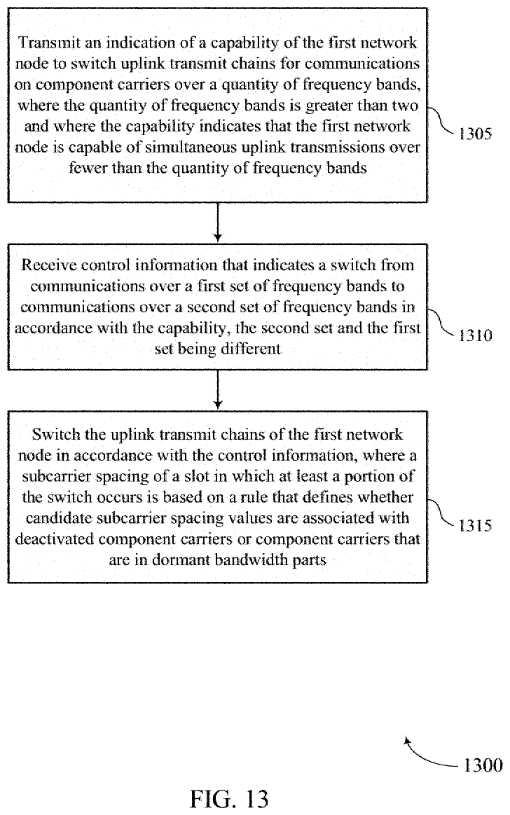

FIG. 13 illustrates a flowchart showing a method 1300 that supports techniques for frequency switching for uplink transmission for a set of multiple bands in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some aspects, a UE may execute a set of instructions to control the functional elements of the UE to perform the described functions. Additionally, or alternatively, the UE may perform aspects of the described functions using special-purpose hardware.

At 1305, the method may include transmitting an indication of a capability of the first network node to switch uplink transmit chains for communications on component carriers over a quantity of frequency bands, where the quantity of frequency bands is greater than two and where the capability indicates that the first network node is capable of simultaneous uplink transmissions over fewer than the quantity of frequency bands. The operations of 1305 may be performed in accordance with examples as disclosed herein. In some aspects, aspects of the operations of 1305 may be performed by a control information reception manager 725 as described with reference to FIG. 7.

At 1310, the method may include receiving control information that indicates a switch from communications over a first set of frequency bands to communications over a second set of frequency bands in accordance with the capability, the second set and the first set being different. The operations of 1310 may be performed in accordance with examples as disclosed herein. In some aspects, aspects of the operations of 1310 may be performed by an uplink transmit chains manager 730 as described with reference to FIG. 7.

At 1315, the method may include switching the uplink transmit chains of the first network node in accordance with the control information, where a SCS of a slot in which at least a portion of the switch occurs is based on a rule that defines whether candidate SCS values are associated with deactivated component carriers or component carriers that are in dormant BWPs. The operations of 1315 may be performed in accordance with examples as disclosed herein. In some aspects, aspects of the operations of 1315 may be performed by an uplink transmit chains manager 730 as described with reference to FIG. 7.

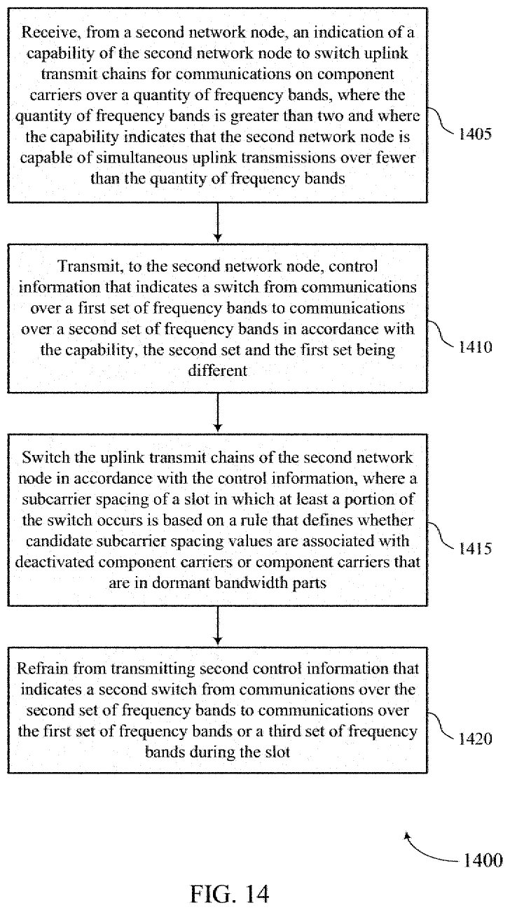

FIG. 14 illustrates a flowchart showing a method 1400 that supports techniques for frequency switching for uplink transmission for a set of multiple bands in accordance with one or more aspects of the present disclosure. The operations of the method 1400 may be implemented by a network entity or its components as described herein. For example, the operations of the method 1400 may be performed by a network entity as described with reference to FIGS. 1 through 4 and 9 through 12. In some aspects, a network entity may execute a set of instructions to control the functional elements of the network entity to perform the described functions.

Additionally, or alternatively, the network entity may perform aspects of the described functions using special-purpose hardware.

At 1405, the method may include receiving, from a second network node, an indication of a capability of the second network node to switch uplink transmit chains for communications on component carriers over a quantity of frequency bands, where the quantity of frequency bands is greater than two and where the capability indicates that the second network node is capable of simultaneous uplink transmissions over fewer than the quantity of frequency bands. The operations of 1405 may be performed in accordance with examples as disclosed herein. In some aspects, aspects of the operations of 1405 may be performed by a control information transmission manager 1125 as described with reference to FIG. 11.

At 1410, the method may include transmitting, to the second network node, control information that indicates a switch from communications over a first set of frequency bands to communications over a second set of frequency bands in accordance with the capability, the second set and the first set being different. The operations of 1410 may be performed in accordance with examples as disclosed herein. In some aspects, aspects of the operations of 1410 may be performed by an uplink transmit chains manager 1130 as described with reference to FIG. 11.

At 1415, the method may include switching the uplink transmit chains of the second network node in accordance with the control information, where a SCS of a slot in which at least a portion of the switch occurs is based on a rule that defines whether candidate SCS values are associated with deactivated component carriers or component carriers that are in dormant BWPs. The operations of 1415 may be performed in accordance with examples as disclosed herein. In some aspects, aspects of the operations of 1415 may be performed by a control information transmission manager 1125 as described with reference to FIG. 11.

At 1420, the method may include refraining from transmitting second control information that indicates a second switch from communications over the second set of frequency bands to communications over the first set of frequency bands or a third set of frequency bands during the slot. The operations of 1420 may be performed in accordance with examples as disclosed herein. In some aspects, aspects of the operations of 1420 may be performed by a control information transmission manager 1125 as described with reference to FIG. 11.

The following provides an overview of aspects of the present disclosure:
Aspect 1: A first network node for wireless communications, comprising: a memory; and at least one processor coupled to the memory, wherein the at least one processor is configured to: transmit an indication of a capability of the first network node to switch uplink transmit chains for communications on component carriers over a quantity of frequency bands, wherein the quantity of frequency bands is greater than two and wherein the capability indicates that the first network node is capable of simultaneous uplink transmissions over fewer than the quantity of frequency bands; receive control information that indicates a switch from communications over a first set of frequency bands to communications over a second set of frequency bands in accordance with the capability, the second set of frequency bands and the first set of frequency bands being different; and switch the uplink transmit chains of the first network node in accordance with the control information, wherein a subcarrier spacing of a slot in which at least a portion of the switch occurs is based on a rule that defines whether candidate subcarrier spacing values are associated with deactivated component carriers or component carriers that are in dormant bandwidth parts.
Aspect 2: The first network node of aspect 1, wherein the at least one processor is further configured to determine the subcarrier spacing of the slot in accordance with the rule, wherein the rule defines that the subcarrier spacing of the slot is based on a maximum numerology of the candidate subcarrier spacing values, and wherein all of the candidate subcarrier spacing values are associated with activated component carriers or component carriers that are in non-dormant bandwidth parts.
Aspect 3: The first network node of any of aspects 1 through 2, wherein the at least one processor is further configured to determine the subcarrier spacing of the slot in accordance with the rule, wherein the rule defines that the subcarrier spacing of the slot is based on a maximum numerology of the candidate subcarrier spacing values, and wherein the candidate subcarrier spacing values are associated with a combination of activated component carriers or component carriers that are in non-dormant bandwidth parts and the deactivated component carriers or the component carriers that are in dormant bandwidth parts.
Aspect 4: The first network node of aspect 3, wherein the candidate subcarrier spacing values associated with the deactivated component carriers or the component carriers that are in dormant bandwidth parts are based on a first active uplink bandwidth part identification associated with respective ones of the deactivated component carriers or dormant bandwidth parts.
Aspect 5: The first network node of any of aspects 1 through 4, wherein the quantity of frequency bands is three or four.
Aspect 6: The first network node of any of aspects 1 through 5, wherein the capability indicates that the first network node is capable of simultaneous uplink transmissions over a maximum of two frequency bands using two uplink transmit chains.
Aspect 7: The first network node of any of aspects 1 through 6, wherein the first set of frequency bands is a single frequency band over which the first network node communicates using a first uplink transmit chain and a second uplink transmit chain, and the second set of frequency bands includes a first frequency band over which the first network node communicates using the first uplink transmit chain and a second frequency band over which the first network node communicates using the second uplink transmit chain.
Aspect 8: The first network node of any of aspects 1 through 7, wherein the first set of frequency bands includes a first frequency band over which the first network node communicates using a first uplink transmit chain and a second frequency band over which the first network node communicates using a second uplink transmit chain, and the second set of frequency bands is a single frequency band over which the first network node communicates using both the first uplink transmit chain and the second uplink transmit chain.
Aspect 9: The first network node of any of aspects 1 through 8, wherein the first set of frequency bands is a first single frequency band over which the first network node communicates using a first uplink transmit chain and a second uplink transmit chain, and the second set of frequency bands is a second single frequency band over which the first network node communicates using both the first uplink transmit chain and the second uplink transmit chain.
Aspect 10: The first network node of any of aspects 1 through 9, wherein the first set of frequency bands includes a first frequency band over which the first network node communicates using a first uplink transmit chain and a second frequency band over which the first network node communicates using a second uplink transmit chain, and the second set of frequency bands includes a third frequency band over which the first network node communicates using the first uplink transmit chain and a fourth frequency band over which the first network node communicates using the second uplink transmit chain.
Aspect 11: The first network node of any of aspects 1 through 10, wherein the control information indicates whether the component carriers are activated or deactivated.
Aspect 12: The first network node of any of aspects 1 through 11, wherein the control information indicates whether the component carriers are in dormant bandwidth parts or non-dormant bandwidth parts.
Aspect 13: A first network node for wireless communications, comprising: a memory; and at least one processor coupled to the memory, wherein the at least one processor is configured to: receive, from a second network node, an indication of a capability of the second network node to switch uplink transmit chains for communications on component carriers over a quantity of frequency bands, wherein the quantity of frequency bands is greater than two and wherein the capability indicates that the second network node is capable of simultaneous uplink transmissions over fewer than the quantity of frequency bands; transmit, to the second network node, control information that indicates a switch from communications over a first set of frequency bands to communications over a second set of frequency bands in accordance with the capability, the second set of frequency bands and the first set of frequency bands being different; switch the uplink transmit chains of the second network node in accordance with the control information, wherein a subcarrier spacing of a slot in which at least a portion of the switch occurs is based on a rule that defines whether candidate subcarrier spacing values are associated with deactivated component carriers or component carriers that are in dormant bandwidth parts; and refrain from transmitting second control information that indicates a second switch from communications over the second set of frequency bands to communications over the first set of frequency bands or a third set of frequency bands during the slot.
Aspect 14: The first network node of aspect 13, wherein the at least one processor is further configured to determine the subcarrier spacing of the slot in accordance with the rule, the rule defines that the subcarrier spacing of the slot is based on a maximum numerology of the candidate subcarrier spacing values, and all of the candidate subcarrier spacing values are associated with activated component carriers or component carriers that are in non-dormant bandwidth parts.
Aspect 15: The first network node of any of aspects 13 through 14, wherein the at least one processor is further configured to determine the subcarrier spacing of the slot in accordance with the rule, the rule defines that the subcarrier spacing of the slot is based on a maximum numerology of the candidate subcarrier spacing values, and the candidate subcarrier spacing values are associated with a combination of activated component carriers or component carriers that are in non-dormant bandwidth parts and the deactivated component carriers or the component carriers that are in dormant bandwidth parts.
Aspect 16: The first network node of aspect 15, wherein the candidate subcarrier spacing values associated with the deactivated component carriers or the component carriers that are in dormant bandwidth parts are based on a first active uplink bandwidth part identification associated with respective ones of the deactivated component carriers or dormant bandwidth parts.
Aspect 17: The first network node of any of aspects 13 through 16, wherein the quantity of frequency bands is three or four.
Aspect 18: The first network node of any of aspects 13 through 17, wherein the capability indicates that the second network node is capable of simultaneous uplink transmissions over a maximum of two frequency bands using two uplink transmit chains.
Aspect 19: The first network node of any of aspects 13 through 18, wherein the first set of frequency bands is a single frequency band over which the second network node communicates using a first uplink transmit chain and a second uplink transmit chain, and the second set of frequency bands includes a first frequency band over which the second network node communicates using the first uplink transmit chain and a second frequency band over which the second network node communicates using the second uplink transmit chain.
Aspect 20: The first network node of any of aspects 13 through 19, wherein the first set of frequency bands includes a first frequency band over which the second network node communicates using a first uplink transmit chain and a second frequency band over which the second network node communicates using a second uplink transmit chain, and the second set of frequency bands is a single frequency band over which the second network node communicates using both the first uplink transmit chain and the second uplink transmit chain.
Aspect 21: The first network node of any of aspects 13 through 20, wherein the first set of frequency bands is a first single frequency band over which the second network node communicates using a first uplink transmit chain and a second uplink transmit chain, and the second set of frequency bands is a second single frequency band over which the second network node communicates using both the first uplink transmit chain and the second uplink transmit chain.
Aspect 22: The first network node of any of aspects 13 through 21, wherein the first set of frequency bands includes a first frequency band over which the second network node communicates using a first uplink transmit chain and a second frequency band over which the second network node communicates using a second uplink transmit chain, and the second set of frequency bands includes a third frequency band over which the second network node communicates using the first uplink transmit chain and a fourth frequency band over which the second network node communicates using the second uplink transmit chain.
Aspect 23: The first network node of any of aspects 13 through 22, wherein the control information indicates whether the component carriers are activated or deactivated.
Aspect 24: The first network node of any of aspects 13 through 23, wherein the control information indicates whether the component carriers are in dormant bandwidth parts or non-dormant bandwidth parts.
Aspect 25: A method of wireless communications performed by a first network node, comprising: transmitting an indication of a capability of the first network node to switch uplink transmit chains for communications on component carriers over a quantity of frequency bands, wherein the quantity of frequency bands is greater than two and wherein the capability indicates that the first network node is capable of simultaneous uplink transmissions over fewer than the quantity of frequency bands; receiving control information that indicates a switch from communications over a first set of frequency bands to communications over a second set of frequency bands in accordance with the capability, the second set of frequency bands and the first set of frequency bands being different; and switching the uplink transmit chains of the first network node in accordance with the control information, wherein a subcarrier spacing of a slot in which at least a portion of the switch occurs is based on a rule that defines whether candidate subcarrier spacing values are associated with deactivated component carriers or component carriers that are in dormant bandwidth parts.
Aspect 26: The method of aspect 25, comprising: determining the subcarrier spacing of the slot in accordance with the rule, wherein the rule defines that the subcarrier spacing of the slot is based on a maximum numerology of the candidate subcarrier spacing values, and wherein all of the candidate subcarrier spacing values are associated with activated component carriers or component carriers that are in non-dormant bandwidth parts.
Aspect 27: The method of any of aspects 25 through 26, comprising: determining the subcarrier spacing of the slot in accordance with the rule, wherein the rule defines that the subcarrier spacing of the slot is based on a maximum numerology of the candidate subcarrier spacing values, and wherein the candidate subcarrier spacing values are associated with a combination of activated component carriers or component carriers that are in non-dormant bandwidth parts and the deactivated component carriers or the component carriers that are in dormant bandwidth parts.
Aspect 28: A method of wireless communications at a first node, comprising: receiving, from a second network node, an indication of a capability of the second network node to switch uplink transmit chains for communications on component carriers over a quantity of frequency bands, wherein the quantity of frequency bands is greater than two and wherein the capability indicates that the second network node is capable of simultaneous uplink transmissions over fewer than the quantity of frequency bands; transmitting, to the second network node, control information that indicates a switch from communications over a first set of frequency bands to communications over a second set of frequency bands in accordance with the capability, the second set of frequency bands and the first set of frequency bands being different; switching the uplink transmit chains of the second network node in accordance with the control information, wherein a subcarrier spacing of a slot in which at least a portion of the switch occurs is based on a rule that defines whether candidate subcarrier spacing values are associated with deactivated component carriers or component carriers that are in dormant bandwidth parts; and refraining from transmitting second control information that indicates a second switch from communications over the second set of frequency bands to communications over the first set of frequency bands or a third set of frequency bands during the slot.
Aspect 29: The method of aspect 28, comprising: determining the subcarrier spacing of the slot in accordance with the rule, wherein the rule defines that the subcarrier spacing of the slot is based on a maximum numerology of the candidate subcarrier spacing values, and wherein all of the candidate subcarrier spacing values are associated with activated component carriers or component carriers that are in non-dormant bandwidth parts.
Aspect 30: The method of any of aspects 28 through 29, comprising: determining the subcarrier spacing of the slot in accordance with the rule, wherein the rule defines that the subcarrier spacing of the slot is based on a maximum numerology of the candidate subcarrier spacing values, and wherein the candidate subcarrier spacing values are associated with a combination of activated component carriers or component carriers that are in non-dormant bandwidth parts and the deactivated component carriers or the component carriers that are in dormant bandwidth parts.
Aspect 31: An apparatus comprising a processor; memory coupled with the processor; and instructions stored in the memory and executable by the processor to cause the apparatus to perform a method of any of aspects 1 through 12.
Aspect 32: An apparatus comprising at least one means for performing a method of any of aspects 1 through 12.
Aspect 33: A non-transitory computer-readable medium storing code the code comprising instructions executable by a processor to perform a method of any of aspects 1 through 12.
Aspect 34: An apparatus comprising a processor; memory coupled with the processor; and instructions stored in the memory and executable by the processor to cause the apparatus to perform a method of any of aspects 13 through 24.
Aspect 35: An apparatus comprising at least one means for performing a method of any of aspects 13 through 24.
Aspect 36: A non-transitory computer-readable medium storing code the code comprising instructions executable by a processor to perform a method of any of aspects 13 through 24.
Aspect 37: An apparatus comprising a processor; memory coupled with the processor; and instructions stored in the memory and executable by the processor to cause the apparatus to perform a method of any of aspects 25 through 27.
Aspect 38: An apparatus comprising at least one means for performing a method of any of aspects 25 through 27.
Aspect 39: A non-transitory computer-readable medium storing code the code comprising instructions executable by a processor to perform a method of any of aspects 25 through 27.
Aspect 40: An apparatus comprising a processor; memory coupled with the processor; and instructions stored in the memory and executable by the processor to cause the apparatus to perform a method of any of aspects 28 through 30.
Aspect 41: An apparatus comprising at least one means for performing a method of any of aspects 28 through 30.
Aspect 42: A non-transitory computer-readable medium storing code the code comprising instructions executable by a processor to perform a method of any of aspects 28 through 30.

The methods described herein describe possible implementations, and the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the drawings, describes example configurations and does not represent all the examples that may be implemented or that are within the scope of the claims. The term “aspect” or “example” used herein means “serving as an aspect, example, instance, or illustration,” and not “preferred” or “advantageous over other aspects.” The detailed description includes specific details for the purpose of providing an understanding of the described techniques. These techniques, however, may be practiced without these specific details. In some instances, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A first network node for wireless communications, comprising:
a memory; and
at least one processor coupled to the memory, wherein the at least one processor is configured to:
transmit an indication of a capability of the first network node to switch uplink transmit chains for communications on component carriers over a quantity of frequency bands, wherein the quantity of frequency bands is greater than two and wherein the capability indicates that the first network node is capable of simultaneous uplink transmissions over fewer than the quantity of frequency bands;
receive control information that indicates a switch from communications over a first set of frequency bands to communications over a second set of frequency bands in accordance with the capability, the second set of frequency bands and the first set of frequency bands being different; and
switch the uplink transmit chains of the first network node in accordance with the control information, wherein a subcarrier spacing of a slot in which at least a portion of the switch occurs is based on a rule that defines whether candidate subcarrier spacing values are associated with deactivated component carriers or component carriers that are in dormant bandwidth parts.

2. The first network node of claim 1, wherein the at least one processor is further configured to:
determine the subcarrier spacing of the slot in accordance with the rule, wherein the rule defines that the subcarrier spacing of the slot is based on a maximum numerology of the candidate subcarrier spacing values, and wherein all of the candidate subcarrier spacing values are associated with activated component carriers or component carriers that are in non-dormant bandwidth parts.

3. The first network node of claim 1, wherein the at least one processor is further configured to:
determine the subcarrier spacing of the slot in accordance with the rule, wherein the rule defines that the subcarrier spacing of the slot is based on a maximum numerology of the candidate subcarrier spacing values, and wherein the candidate subcarrier spacing values are associated with a combination of activated component carriers or component carriers that are in non-dormant bandwidth parts and the deactivated component carriers or the component carriers that are in dormant bandwidth parts.

4. The first network node of claim 3, wherein the candidate subcarrier spacing values associated with the deactivated component carriers or the component carriers that are in dormant bandwidth parts are based on a first active uplink bandwidth part identification associated with respective ones of the deactivated component carriers or dormant bandwidth parts.

5. The first network node of claim 1, wherein the quantity of frequency bands is three or four.

6. The first network node of claim 1, wherein the capability indicates that the first network node is capable of simultaneous uplink transmissions over a maximum of two frequency bands using two uplink transmit chains.

7. The first network node of claim 1, wherein the first set of frequency bands is a single frequency band over which the first network node communicates using a first uplink transmit chain and a second uplink transmit chain, and wherein the second set of frequency bands includes a first frequency band over which the first network node communicates using the first uplink transmit chain and a second frequency band over which the first network node communicates using the second uplink transmit chain.

8. The first network node of claim 1, wherein the first set of frequency bands includes a first frequency band over which the first network node communicates using a first uplink transmit chain and a second frequency band over which the first network node communicates using a second uplink transmit chain, and wherein the second set of frequency bands is a single frequency band over which the first network node communicates using both the first uplink transmit chain and the second uplink transmit chain.

9. The first network node of claim 1, wherein the first set of frequency bands is a first single frequency band over which the first network node communicates using a first uplink transmit chain and a second uplink transmit chain, and wherein the second set of frequency bands is a second single frequency band over which the first network node communicates using both the first uplink transmit chain and the second uplink transmit chain.

10. The first network node of claim 1, wherein the first set of frequency bands includes a first frequency band over which the first network node communicates using a first uplink transmit chain and a second frequency band over which the first network node communicates using a second uplink transmit chain, and wherein the second set of frequency bands includes a third frequency band over which the first network node communicates using the first uplink transmit chain and a fourth frequency band over which the first network node communicates using the second uplink transmit chain.

11. The first network node of claim 1, wherein the control information indicates whether the component carriers are activated or deactivated.

12. The first network node of claim 1, wherein the control information indicates whether the component carriers are in dormant bandwidth parts or non-dormant bandwidth parts.

13. A first network node for wireless communications, comprising:
a memory; and
at least one processor coupled to the memory, wherein the at least one processor is configured to:
receive, from a second network node, an indication of a capability of the second network node to switch uplink transmit chains for communications on component carriers over a quantity of frequency bands, wherein the quantity of frequency bands is greater than two and wherein the capability indicates that the second network node is capable of simultaneous uplink transmissions over fewer than the quantity of frequency bands;
transmit, to the second network node, control information that indicates a switch from communications over a first set of frequency bands to communications over a second set of frequency bands in accordance with the capability, the second set of frequency bands and the first set of frequency bands being different;
switch the uplink transmit chains of the second network node in accordance with the control information, wherein a subcarrier spacing of a slot in which at least a portion of the switch occurs is based on a rule that defines whether candidate subcarrier spacing values are associated with deactivated component carriers or component carriers that are in dormant bandwidth parts; and
refrain from transmitting second control information that indicates a second switch from communications over the second set of frequency bands to communications over the first set of frequency bands or a third set of frequency bands during the slot.

14. The first network node of claim 13, wherein the at least one processor is further configured to determine the subcarrier spacing of the slot in accordance with the rule, wherein the rule defines that the subcarrier spacing of the slot is based on a maximum numerology of the candidate subcarrier spacing values, and wherein all of the candidate subcarrier spacing values are associated with activated component carriers or component carriers that are in non-dormant bandwidth parts.

15. The first network node of claim 13, wherein the at least one processor is further configured to determine the subcarrier spacing of the slot in accordance with the rule, wherein the rule defines that the subcarrier spacing of the slot is based on a maximum numerology of the candidate subcarrier spacing values, and wherein the candidate subcarrier spacing values are associated with a combination of activated component carriers or component carriers that are in non-dormant bandwidth parts and the deactivated component carriers or the component carriers that are in dormant bandwidth parts.

16. The first network node of claim 15, wherein the candidate subcarrier spacing values associated with the deactivated component carriers or the component carriers that are in dormant bandwidth parts are based on a first active uplink bandwidth part identification associated with respective ones of the deactivated component carriers or dormant bandwidth parts.

17. The first network node of claim 13, wherein the quantity of frequency bands is three or four.

18. The first network node of claim 13, wherein the capability indicates that the second network node is capable of simultaneous uplink transmissions over a maximum of two frequency bands using two uplink transmit chains.

19. The first network node of claim 13, wherein the first set of frequency bands is a single frequency band over which the second network node communicates using a first uplink transmit chain and a second uplink transmit chain, and wherein the second set of frequency bands includes a first frequency band over which the second network node communicates using the first uplink transmit chain and a second frequency band over which the second network node communicates using the second uplink transmit chain.

20. The first network node of claim 13, wherein the first set of frequency bands includes a first frequency band over which the second network node communicates using a first uplink transmit chain and a second frequency band over which the second network node communicates using a second uplink transmit chain, and wherein the second set of frequency bands is a single frequency band over which the second network node communicates using both the first uplink transmit chain and the second uplink transmit chain.

21-30. (canceled)
